(19) United States
(12) Patent Application Publication
(10) Pub. No.: US 2023/0419303 A1
(43) Pub. Date: Dec. 28, 2023

(54) VIDEO DATA TRANSMISSION METHOD, VIDEO DATA TRANSMISSION SYSTEM, AND NON-TRANSITORY COMPUTER-READABLE STORAGE MEDIUM STORING VIDEO DATA TRANSMISSION PROGRAM

(71) Applicant: GREE, Inc., Tokyo (JP)

(72) Inventors: Eiji ARAKI, Tokyo (JP); Ikumi AKATSUKA, Tokyo (JP); Joe SHEN, Tokyo (JP)

(21) Appl. No.: 17/961,287

(22) Filed: Oct. 6, 2022

Related U.S. Application Data
(60) Provisional application No. 63/355,159, filed on Jun. 24, 2022.

(51) Int. Cl. G06Q 20/36

(52) U.S. Cl. CPC G06Q 20/3672

(57) ABSTRACT

A video data transmission method for transmitting video data is disclosed. The video data includes a view of a virtual space in which a plurality of avatars are allowed to participate. The plurality of avatars is each associated with one of a plurality of users. The video data transmission method according to an aspect includes the step of generating a first wallet in association with first user identification information identifying a first user and the step of granting, in response to a first acquisition request from the first user, the first user a first non-fungible asset for use in the virtual space and tokenized as non-fungible tokens. A first non-fungible token associated with the first non-fungible asset is transferred to an address of the first wallet.

### CROSS-REFERENCE TO RELATED APPLICATIONS

This application claims the benefit of U.S. Provisional Patent Application No. 63/355,159, filed Jun. 24, 2022, which is incorporated by reference herein in its entirety.

### TECHNICAL FIELD

The present application relates to a video data transmission generally, and more specifically relates to a video data transmission of video containing a view of a virtual space in which non-fungible assets tokenized as non-fungible tokens are used. The disclosure herein also relates to a game in which non-fungible assets tokenized as non-fungible tokens are used. The disclosure herein further relates to other applications in which non-fungible assets tokenized as non-fungible tokens are used.

### BACKGROUND

There have been services using platforms for building virtual spaces with objects tokenized as non-fungible tokens (NFTs). For example, a user can participate through his/her own avatar in a virtual space containing tokenized objects and interact with avatars of other users participating in the virtual space. The user device of the user may receive a video containing a view of the virtual space taken by a virtual camera installed in the virtual space.

Platforms in which tokenized objects are used to build virtual spaces may have implemented thereon an editor used by users. Users can use this editor to create objects in the virtual space, such as avatars, buildings, and items that constitute the virtual spaces, for example, on a voxel basis. The objects constituting the virtual spaces created by the users may be tokenized as NFTs. The NFTs associated with the objects in a virtual space may be traded in a marketplace for this virtual space or in a marketplace operated by an operator different than this virtual space. A parcel of virtual land in a virtual space may be tokenized as an NFT. Since the NFTs can be traded using crypto assets in the marketplace, objects tokenized as NFTs and parcels in the virtual space tokenized as NFTs may also have asset values in the real world.

The NFTs may be traded using crypto assets such as ERC-20 tokens issued in accordance with ERC-20. Crypto assets such as ERC-20 tokens may be used for NFT trades (e.g., purchases, sales, and exchanges).

### SUMMARY

In services with virtual spaces containing objects tokenized as NFTs, users who start to use the service may need to prepare an environment for trades using crypto assets in order to tokenize the objects as NFTs (e.g., minting) or trade NFTs. For example, at the start of using the service, a user is required to set up the user's device for cooperation between an application (an application program) for using the service and a cryptocurrency wallet (e.g., an ERC-721-compatible wallet). Many users are not familiar with cryptocurrency wallets (hereafter simply referred to as “wallets”), and the need to prepare a wallet may be a barrier to using services with virtual spaces containing objects tokenized as NFTs.

Thus, in conventional services with virtual space in which objects tokenized as NFTs are used, it may be difficult to include or attract users who are not currently using a wallet (e.g., are not already using a wallet when starting the use of such services).

It is an object of the present disclosure to provide a technical improvement which solves or alleviates at least part of the drawbacks of the conventional art mentioned above. One specific object of the present disclosure is to lower the barrier for users of one or more user devices who are without wallets to use virtual space platforms in which objects tokenized as NFTs are used. One specific object of the present disclosure is to lower the barrier for users of user devices without wallets to use of games or other applications in which objects tokenized as NFTs are used.

Other challenges and objects of the invention disclosed in this specification will be apparent with reference to the entire description in this specification. One or more aspects of the invention disclosed herein may solve a challenge that will be apparent with reference to the entire specification.

An aspect of the disclosure relates to a video data transmission method for transmitting video data including a view of a virtual space in which a plurality of avatars are allowed to participate, the plurality of avatars each associated with one of a plurality of users including a first user. The video data transmission method according to an aspect includes the step of generating a first wallet in association with first user identification information identifying the first user in the virtual space. The video data transmission method according to an aspect includes the step of granting, in response to a first acquisition request from the first user, the first user a first non-fungible asset among one or more non-fungible assets that are digital assets for use in the virtual space and tokenized as non-fungible tokens, and transferring a first non-fungible token associated with the first non-fungible asset to an address of the first wallet.

According to the embodiments of the present disclosure, it is possible to lower the barrier for users of user devices without wallets to enter or use virtual space platforms in which objects tokenized as NFTs are used.

### BRIEF DESCRIPTION OF THE DRAWINGS

FIG. 1 is a block diagram illustrating a video transmission system 1 according to one embodiment.

FIG. 2 shows an example of a view of a virtual space including an avatar.

FIG. 3 is a schematic view illustrating an example of a blockchain.

FIG. 4 illustrates data structure of an NFT.

FIG. 5 is a block diagram illustrating the functions of the server provided in the video transmission system 1 of FIG. 1.

FIG. 6 illustrates user assets used in the video transmission system 1.

FIG. 7 is a schematic diagram illustrating an example of an item purchase screen.

FIG. 8 is a schematic diagram illustrating the conversion of a fungible asset to a non-fungible asset.

FIG. 9 illustrates an example of a dress-up screen for selecting items to be worn by the avatar.

FIG. 10 illustrates asset management data stored in the video transmission system 1 of FIG. 1.

FIG. 11 illustrates user management data stored in the video transmission system 1 of FIG. 1.

FIG. 12 illustrates avatar management data stored in the video transmission system 1 of FIG. 1.

FIG. 13 is a schematic diagram illustrating an example of a room selection screen for selecting a video to view.

FIG. 14 is a schematic diagram illustrating an example of a trading screen for trading non-fungible assets.

FIG. 15 is a flow diagram showing the process of a user A acquiring a non-fungible asset using a wallet hosted on a server.

FIG. 16 is a flow diagram showing the process of acquiring a non-fungible asset using a user wallet.

FIG. 17 is a flow diagram showing the process of a user C acquiring a non-fungible asset.

FIG. 18 is a flow diagram showing the process of a user B tokenizing a fungible asset as an NFT.

FIG. 19 is a flow diagram showing the process of the user A tokenizing a fungible asset as an NFT.

FIG. 20 is a flow diagram showing the process of the user C tokenizing a fungible asset as an NFT.

FIG. 21 schematically shows an example of an asset list displayed on a user device.

FIG. 22 schematically shows an example of an NFT issuance screen for tokenizing a fungible asset as an NFT.

FIG. 23 shows an example of a video played on a user device.

FIG. 24 shows an example of a co-performing video.

FIG. 25 shows archived video data.

FIG. 26 shows video data related to a co-performing video.

### DETAILED DESCRIPTION

Various embodiments of the invention disclosed herein (hereinafter also referred to as “the present invention”) will be described hereinafter with reference to the appended drawings. Throughout the drawings, the same components may be denoted by the same reference numerals. The following embodiments of the present invention do not limit the scope of the claims. The elements described in the following embodiments are not necessarily essential to solve the problem addressed by the invention.

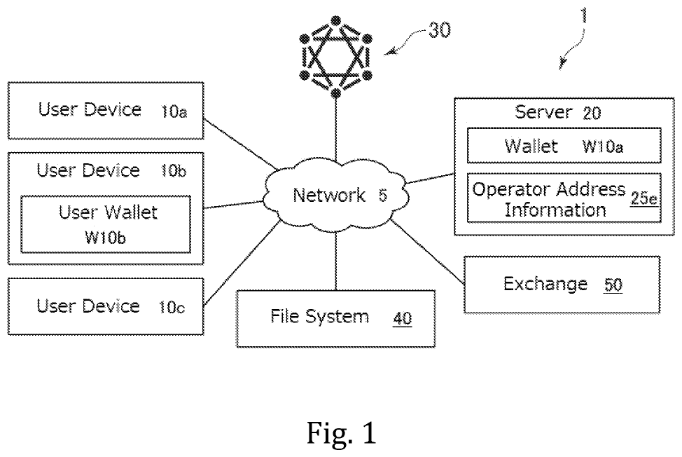

FIG. 1 is a block diagram illustrating a video transmission system 1 according to one embodiment. The video transmission system 1 shown in FIG. 1 includes a server 20. The server 20 is communicatively connected to a user device 10a, a user device 10b, a user device 10c, a blockchain network 30, a file system 40, and an exchange 50 via a network 5. In addition to the server 20, some or all of the user device 10a, the user device 10b, the user device 10c, the blockchain network 30, and the file system 40 may be components of the video transmission system 1.

The network 5 may be a single network or may be a plurality of networks connected to each other. The network 5 is, for example, the Internet, a mobile communication network, or a combination thereof. Any network enabling communication between electronic devices can be used as the network 5.

In the video transmission system 1, video data is transmitted from the server 20 to the user devices 10a, 10b, 10c. When receiving the video data from the server 20, the user devices 10a, 10b, 10c can play a video generated based on the video data. The video is generated as a sequence of video frames. The respective users of the user devices 10a, 10b, 10c can view the video played on the user devices. The video data can include object data related to objects contained in a virtual space (e.g., data identifying objects placed in the virtual space, and coordinate data indicating the positions in the virtual space of the objects placed in the virtual space), avatar display data representing the appearance of an avatar, motion data representing motions of the avatar, and various other data necessary for generating a video. The motion data representing the motions of the avatar may be a digital representation of the user's facial movements (changes in facial expression) or body movements in a time series. The motion data can be generated by a camera on the user device or a motion sensor attached to the user. The motion data may be generated as needed over time. The motion data may be generated at predetermined sampling time intervals. The video data can be rendered based on the motion data to generate a video containing animations of an avatar that moves in sync with changes in the user's facial expressions and body movements.

Generation of the video based on the video data may be performed by any of the devices included in the video transmission system. In one or more aspect, generation of the video based on the video data may be performed by each of the user devices 10a, 10b, 10c. For example, generation of the video based on the video data may be performed by executing a rendering application program (e.g., a rendering engine) on the user device. The method of generating the video from the video data by executing a rendering application program on each of the user devices 10a, 10b, 10c may be herein referred to as the “client rendering method.” The video transmission system 1 can employ the client rendering method. In the client rendering method, each of the user devices 10a, 10b, 10c may obtain a rendering application from, for example, an application distribution platform before generating the video. Each of the user devices 10a, 10b, 10c may retain the avatar display data representing the avatar's appearance before the video playback process is started. In the client rendering method, each of the user devices 10a, 10b, 10c can receive from the server 20 the avatar identification information (e.g., avatar ID), the motion data representing the avatar's motions, audio data, and, if necessary, information necessary for rendering other than the aforementioned, generate the video based on the information received from the server 20 and the information retained in advance, and display the generated video.

In another aspect, generation of the video from the video data may be performed by the user devices 10a, 10b, 10c retrieving a web page from the server 20 and then the computer program (e.g., Java script) included in this web page being executed by a browser provided in the user devices 10a, 10b, 10c. This web page may include description of the location of the data required for generation of the video (e.g., the object data, the avatar display data, and the motion data). For example, the Java script included in the web page can retrieve various data from the data storage location described in the web page and generate a video based on the retrieved data. A browser is software for viewing web pages described in HTML, and is separate from the rendering application program. The browser can be used to view web pages provided by various servers in addition to web pages obtained from the server 20. The method of generating the video from the video data by the browser may be herein referred to as the “browser rendering method.” The video transmission system 1 can employ the browser rendering method.

In still another aspect, generation of the video based on the video data may be performed by the server 20. In the case where the video is generated by the server 20, the video generated at the server 20 is transmitted from the server 20 to the user devices 10a, 10b, 10c. The user devices 10a, 10b, 10c play (e.g., display) the video received from the server 20. The method of generating the video from the video data by the server 20 may be herein referred to as the “server rendering method.” In the server rendering method, the video generated by the server 20 is transmitted to the user devices 10a, 10b, 10c.

As described above, the video transmission system 1 can employ any of the client rendering method, the browser rendering method, and the server rendering method, alone or in combination. Therefore, transmitting the “video data” from the server 20 to the user devices 10a, 10b, 10c includes transmitting the “video” generated from the video data at the server 20. For example, when the video transmission system 1 employs the client rendering method, the server 20 transmits the pre-rendered video data (e.g., the object data, the avatar display data, and the motion data) to the user devices 10a, 10b, 10c. In contrast, when the video transmission system 1 employs the server rendering method, the video generated by the server 20 is transmitted frame by frame from the server 20 to the user devices 10a, 10b, 10c. In other words, the “video data” transmitted from the server 20 to the user devices 10a, 10b, 10c may herein be either pre-rendered video data or rendered video data (i.e., a video generated from the pre-rendered video data).

In this way, the server 20 provides video transmission services to the user devices 10a, 10b, 10c and other user devices. For brevity of explanation, only three user devices are illustrated in FIG. 1, but the server 20 can transmit video data to four or more user devices. It is herein assumed that the user device 10a is used by a user A, the user device 10b is used by a user B, and the user device 10c is used by a user C. The term “user device” herein refers to a device used by a user to use the video transmission service provided by the server 20.

The user devices 10a, 10b, 10c may store a video playback application for playing the video data transmitted from the server 20. The instructions contained in the video playback application may be executed by the respective processors of the user devices 10a, 10b, 10c. A rendering application program (e.g., rendering engine) that generates video based on the video data may be a part of the video playback application. The video playback applications may be downloaded to the user devices 10a, 10b, 10c, for example, from an application distribution platform (not shown).

The provider of server 20 (e.g., an entity providing the server) can operate a virtual space (virtual space platform) and provide services using the virtual space to the users. The video data transmitted from the server 20 may include data representing a view of the virtual space taken by a virtual camera facing toward some area of the virtual space. The server 20 provides a user with various objects that constitute the virtual space, and the user can construct a part or all of the virtual space using the objects provided by the server 20. For example, the user can place objects he or she created in the virtual space provided by the server 20. The virtual space provided by the server 20 may have a world defined by a three-dimensional global coordinate system. For example, such that the user's avatar can walk around in the virtual space in response to user operations. The virtual space provided by the server 20 may not have a three-dimensional world defined. If a three-dimensional world is not defined in the virtual space provided by the server 20, the user's avatar may not be able move within the virtual space. In this case, the virtual space may contain the user's avatar and other objects (e.g., objects that constitute the background or objects gifted by other users). In the following description, the entity operating the virtual space provided by the server 20 or the entity operating the video transmission service for transmitting views of the virtual space may be referred to as a “virtual space operator” for convenience.

The server 20 may provide the function for users to create voxel-based objects. In this case, the users can create objects with various voxel-based shapes.

Objects, items, voxels, and other elements constituting the virtual space provided by the server 20 may be collectively referred to as “digital assets” used in the virtual space.

In the video transmission system 1, the video data may be transmitted from the server 20. The video generated from the video data transmitted from the server 20 can include views of the virtual space operated by the virtual space operator. A view of the virtual space is generated based on the various objects constituting the virtual space, the setting information (the position in the virtual space, the gazing position, the gazing direction, and the angle of view) of the virtual camera placed in the virtual space and, if necessary, other information. The view of the virtual space may be a first-person view of the virtual space as seen from the avatar of the user participating in the virtual space (i.e., taken by a virtual camera placed at the same position as the avatar). The view of the virtual space may also be a third-person view of the virtual space taken by a virtual camera placed at a different position than the avatar of the user participating in the virtual space. When a user views a video that includes a third-person view of the virtual space, the view of the virtual space may include the avatar of the user.

The virtual space provided by the server 20 may include a user's avatar. A user can sign in to the video transmission service provided by the server 20 to participate in the virtual space using his/her own avatar. In other words, the user can cause his/her own avatar to appear in the virtual space provided by the server 20. The users can, for example, interact with avatars of other users through his/her own avatar in the virtual space. As an example, the user can interact with other users using text chat, voice chat, or other communication features. In this case, an animation may be generated showing the avatars of the users chatting with each other in the virtual space, and the animation data including the animation may be transmitted to the user devices. The users can also interact with each other in ways other than chatting. For example, the user can play a game in the virtual space with other users. The user may play the game cooperatively with other users or against other users. The avatar of the user may move in the virtual space along with avatars of other users. In this case, the avatar of the user, along with avatars of other users, can participate in events in the virtual space, shop at virtual stores located in the virtual space, or share experiences in the virtual space with other avatars in other ways.

The user may generate objects that can be used and/or placed in the virtual space, or may use objects provided by the virtual space operator. The user may be able to acquire objects from the virtual space operator for a fee or free of charge. Such objects can include objects representing items worn by the avatar, avatars or characters other than avatars or portions (e.g., head, hairstyle, eyes, nose, mouth, etc.) of the avatar, avatars or characters other than avatars, background objects that constitute the avatar's background, objects representing interiors placed in the virtual space, and items, tools, equipment, weapons, and other in-game objects used in the game. The user may place the created object in the virtual space. The user may interact with objects placed in the virtual space. For example, the user may move, destroy, or modify objects in the virtual space. The user may play games provided in the virtual space. When the user plays a game provided in the virtual space, objects owned by the user may be usable in that game. The user may acquire, purchase, exchange, rent, or sell digital assets such as objects and items in the virtual space.

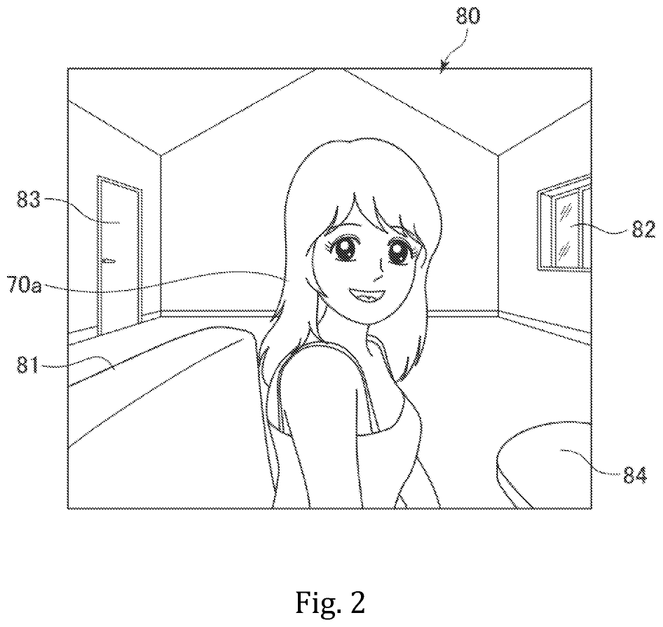

FIG. 2 shows an example of a view of the virtual space provided by the server 20. The view 80 of the virtual space shown in FIG. 2 includes a portion of the virtual space and the avatar 70a of the user A. The view of the virtual space may include two or more avatars. The virtual space may include various objects. The view shown in FIG. 2, is generated by taking the avatar 70a in a room of a house placed in the virtual space with a virtual camera placed in the virtual space. This room in the virtual space contains objects 81, 82, 83, 84. The avatar 70a may move in the virtual space in response to the operation of the user device 10 by the user A. Some or all of the objects 81, 82, 83, 84 may be placed previously in the virtual space by the virtual space operator. Some or all of the objects 81, 82, 83, 84 may be placed in the virtual space by the user. In some embodiments, the user may remove (e.g., delete) the objects 81, 82, 83, 84 from the virtual space or move their locations.

In the virtual space provided by the server 20, the avatar of the user A may be generated or rendered to move or otherwise alter appearance in the virtual space in accordance with the facial expressions and/or body movements of the user A captured by the user device 10a. The virtual space may contain multiple avatars corresponding to multiple users, not only the avatar of the user A. The virtual space may also contain characters (e.g., Minecraft Mobs) moving in the virtual space, in addition to avatars of the users. The characters moving in the virtual space may appear (or be spawned) at predetermined locations in the virtual space based on a predetermined algorithm.

The virtual space provided by the server 20 may be a metaverse space. Multiple users can participate in this metaverse space simultaneously through their own avatars. In this specification, the “virtual space” also includes the “metaverse space.” The social activities virtually reproduced in the metaverse space include interaction among users, works in which multiple users participate, play in which multiple users participate, and other social activities in the real world. The users can participate in the metaverse space through their own avatars. The world of the metaverse space may be defined in a three-dimensional global coordinate system. The avatars of the users can freely walk around in the world of the metaverse space and communicate with each other.

A user who causes videos generated from the video data to be transmitted from the server 30 and/or to be played by user devices (e.g., user devices 10a, 10b, 10c) may be referred to as a distributor user. The server 20 may transmit video data of a video whose distributor user is one of the multiple users participating in the virtual space through their avatars. If one of the users is a distributor user, the video distributed by this distributor user may contain a view of the virtual space that includes the avatar of this user. A view of the virtual space that contains an avatar of a user can be generated by setting the setting information (e.g., the position in the virtual space, the gazing position, the gazing direction, and the angle of view) of a virtual camera placed in the virtual space such that the view contains the avatar.

A user who views videos generated from the video data transmitted from the server 20 may be referred to as a viewer user. The distinction between a distributor user and a viewer user is not fixed. When a user participating in the virtual space distributes a video, this user remains a distributor user while distributing the video, but this user is a viewer user while viewing videos distributed by other users without distributing a video. Further, the user is neither a distributor user nor a viewer user while interacting with other users in the virtual space through avatars without distributing or viewing a video. Thus, rather than a specific user being fixed as a distributor user, the user who distributes a video among the users participating in the virtual space is referred to as the distributor user for that video.

The distributor user may distribute solo videos that include his/her own avatar and no other users' avatars, or may collaborate with other users to distribute collaborative videos that include multiple users' avatars. The distributor user may host a video chat or a voice chat in which multiple users can participate and distribute this video chat or voice chat. The distributor user may host or organize an event (e.g., a party) in the virtual space in which multiple users can participate and distribute this event.

A viewer user views videos distributed from the distributor user. A viewer user may not only view the video, but may also input reactions to the video being viewed into his/her own user devices. When a viewer user participates in a collaborative distribution as a guest, this viewer user may be referred to as a guest user. When a viewer user participates in a video chat, voice chat, or event, this viewer user may be referred to as a participating user. When a viewer user does not participate in a video chat or voice chat but only views it, this viewer user may be referred to as a listener.

A video generated from the video data transmitted by the video transmission system 1 contains a view of the virtual space. The view of the virtual space is a partial rendered area of the virtual space that is defined based on the setting information of the virtual camera (e.g., the position in the virtual space, the gazing position, the gazing direction, and the angle of view). The view 80 of the virtual space contained in the video played on the user device 10a of the user A may be defined to include the avatar 70a of the user A. As described above, the view 80 of the virtual space may be defined from the point of view of the avatar 70a (i.e., first-person view). The view of the virtual space defined from the point of view of the avatar 70a may not include the avatar 70a at all, or may include only a portion of the avatar 70a (e.g., fingers) that is in the field of vision of the avatar 70a.

The user A can transmit a distribution request via the user device 10a to the server 20. The distribution request may be to request distribution of a video containing a view of the virtual space to other users. This view of the virtual space may or may not include the avatar 70a, as described above. A video distributed at the request of the user A may be referred to as “a distributed video of the user A” or “a distributed video from the user A.” Upon receiving a video distribution request from the user A, the server 20 may create a room for the user A. Other users may view videos of the user A by accessing the room of the user A. In some embodiments, users of the video transmission system 1 can distribute videos including virtual spaces and can also view videos distributed by other users. In one or more embodiment, a viewer user can view a video containing a view of the virtual space including the avatar 70a by accessing the room of the user A. In some embodiments, a viewer user does not need to access the room of the user A to view a video including the view of the virtual space generated including the avatar 70a of the user A in the virtual space. For example, the virtual camera may be set to track the avatar 70a as it moves in the virtual space, such that a view of the virtual space that includes the avatar 70a may be generated, and the viewer user can view a video including the view of the virtual space, such as from the perspective of the virtual camera, that includes the avatar 70a generated in this way. In another example, the virtual camera may be fixed at a specific position in the virtual space. For example, a virtual camera may be fixedly installed in a virtual event space within the virtual space, and a video containing the view of the virtual space generated by this fixed virtual camera may be generated. In this case, when the avatar 70a moves to the event space in the virtual space, the video generated may include the avatar 70a.

The user devices 10a, 10b, 10c are information processing devices capable of playing video data transmitted from the server 20 or a video generated from the video data. The user devices 10a, 10b, 10c are, for example, smartphones, personal computers (PCs), mobile phones, tablet terminals, personal computers, e-book readers, wearable computers, game consoles, head mounted displays, or various other information processing devices. Although not shown, each of the user devices 10b, 10c is equipped with a processor, a memory, an input interface for receiving user input, an output interface such as a display and speakers for outputting information, a communication interface, a storage, and other components necessary to enable the user devices 10a, 10b, 10c to operate as information processing devices. The user devices 10a, 10b, 10c may be equipped with a camera. This camera may be a 3D camera capable of detecting the depth of a person's face in order to detect feature points on the user's face.

In the virtual space operated by the operator of the server 20, various digital assets are used, as described above. Some of the digital assets used in this virtual space can be tokenized as non-fungible tokens on the blockchain network 30, as described later in detail. For convenience of explanation, tokenizing a digital asset as a non-fungible token may be herein referred to as “tokenizing” the digital asset “as an NFT.” A virtual space operator holds an address (operator address) that uniquely identifies the virtual space operator in the blockchain network 30 in order to tokenize the digital assets used in the virtual space as NFTs.

The server 20 retains operator address information 25e expressing the address of the virtual space operator in the blockchain network 30. The operator address information 25e is a set of a public key and a private key paired with this public key. When Ethereum is used as the blockchain network 30, the operator address information will be used to implement the ERC-721 compatible wallets and marketplaces. The public key of the operator address information is used as an address unique to the virtual space operator in the blockchain network 30 when issuing or transferring tokens on the blockchain network 30. The private key is used to encrypt (digitally sign) transaction data transmitted to the blockchain network 30 for recording in the blockchain network 30.

Other information processing devices included in the video transmission system 1 (e.g., the user devices 10a, 10b, 10c) may or may not have addresses in the blockchain network 30. In aspects shown in FIG. 1, the user device 10b has or corresponds to a user wallet W10b, whereas the user devices 10a, 10c do not have or correspond to a wallet. Therefore, the user devices 10a, 10c do not have an address for receiving the transfer of tokens such as NFTs in the blockchain network 30. In some embodiments, the server 20 may have (e.g., host) a wallet for one or more users of the services provided by the server 20. For example, the server 20 can manage wallets of the users in association with user identification information that identifies each user in a virtual space-based service (e.g., video transmission service) provided by the server 20. In the example shown in FIG. 1, the server 20 hosts the wallet W10a for the user A in association with the user identification information that identifies the user A in a virtual space-based service. The user A can use the wallet W10a hosted on the server 20 to purchase and generate NFTs and conduct other trades related to NFTs. Thus, the user A, who uses the virtual space-based service provided by the server 20, uses the user device 10a, where the user device 10a may not have a wallet, to use the service. In this case, the user A can use the wallet W10a managed by the server 20 for the user A to conduct trades related to NFTs. Therefore, the virtual space-based service provided by the server 20 can be used not only by users who use a user device having a wallet, but also by users who use a user device not having a wallet. In the example shown in FIG. 1, the server 20 does not host a wallet for the user C. In response to a request from the user C, the server 20 may host a wallet for the user C in association with user identification information that identifies the user C.

Although FIG. 1 illustrates only the wallet W10a associated with the user A as the wallet hosted by the server 20, the server 20 may also have wallets associated with user identification information of other users who use the virtual space. For brevity of explanation, we will focus on the wallet W10a, which is associated with the user A. However, the description of the wallet W10a also applies to other wallets that are managed at the server 20 in association with other users of the virtual space.

The wallet W10a has a public key and a private key paired with this public key, and these keys are managed in association with each other. The public key of the wallet W10a is used as an address unique to the wallet W10a in the blockchain network 30.

In some embodiments, the wallet W10a may be generated in association with the user identification information of the user A when a process such as acquisition of NFTs or tokenization of digital assets as NFTs or other processes requiring the wallet W10a are performed.

In some embodiments, the wallet W10a may be generated in association with the user identification information of the user A when the user A signs up for a service provided by the server 20. For example, the wallet W10a may be generated in response to the user A creating an account for a service provided by the server 20.

The wallet W10a may be a closed wallet that can only be used within the virtual space provided by the server 20. The closed wallet W10a may not be connected to a marketplace or exchange outside the server 20. Therefore, when the closed wallet W10a is used, trades of NFTs and crypto assets are conducted only between users of the services provided by the server 20. In some embodiments, when the closed wallet W10a is used, the NFTs associated with non-fungible assets used in the virtual space provided by the server 20 may be traded in an internal marketplace of the server 20 (described later) but may not be traded in external marketplaces. In some embodiments, the closed wallet W10a may be used to receive utility tokens generated by executing smart contracts (described later).

The wallet W10a may be an open wallet that is connectable to an exchange (e.g., the exchange 50) or a marketplace outside the server 20. When Ethereum is used as the blockchain network 30, the open wallet W10a may be an ERC-721 compatible wallet. MetaMask is known as an ERC-721 compatible wallet.

The wallet W10a may have a first account for serving as a closed wallet and a second account for serving as an open wallet. The user may use the wallet W10a to use these two accounts. The first account may be used for trades inside the server 20, and the second account may be used for trades with the outside of the server 20.

The user wallet W10b provided on the user device 10b has a public key and a private key paired with this public key, and these keys are managed in association with each other. The public key of the user wallet W10b is used as an address unique to the user wallet W10b in the blockchain network 30. The user device 10b can download a user wallet, such as the user wallet W10b, from a known application delivery platform, if necessary. The user wallet downloaded to the user device 10b, such as the user wallet W10b, may be connected to the address of the operator of the server 20 after the download is complete. When Ethereum is used as the blockchain network 30, the user wallet W10b may be an ERC-721 compatible wallet (e.g., MetaMask).

As with the user wallet W10a, the user wallet W10b may be used to conduct trades of NFTs or crypto assets between users of the server 20 or to receive utility tokens. In some embodiments, the server 20 may not generate a wallet associated with the user B. In some embodiments, the server 20 may generate a wallet associated with the user identification information of the user B. In some embodiments, the user B can switch between the user wallet W10b provided on the user device 10b and the wallet hosted by the server 20.

The file system 40 is constituted by multiple nodes, and manages files in a decentralized manner in accordance with IPFS (InterPlanetary File System). IPFS is a P2P hypermedia protocol. Since IPFS is a well-known protocol, it is not described herein. The server 20 may be one of the nodes constituting the file system 40. Some of the digital assets provided by the server 20, such as digital assets tokenized as NFTs (digital assets associated with non-fungible tokens), may be stored on the server 20 for video transmission service. The file system 40 may store backups of the digital assets tokenized as NFTs to reduce the risk of loss of the digital assets tokenized as NFTs.

The exchange 50 is a trading platform for trading between legal tender (e.g., Japanese yen or U.S. dollars) and crypto assets or between crypto assets. The exchange 50 is, for example, a centralized exchange (CEX). The exchange 50 has a digital order book, constituted by a list of open buying and selling orders, and executes trades between assets by matching buyers and sellers. The digital order book contains the seller's selling quantity and selling price and the buyer's buying quantity and buying price. The exchange 50 publishes the exchange rate between crypto assets and legal tender. The exchange 50 may be located outside the video transmission system 1. In other words, the exchange 50 may be operated by an entity different from the operator of the server 20 (the virtual space operator). Binance and Coinbase are known operators of the exchange 50.

The blockchain network 30 is a distributed computing platform constituted by multiple computer nodes and having Byzantine fault tolerance. The blockchain network 30 may be a known public proof-of-work blockchain. For example, Ethereum can be used as the blockchain network 30. The server 20 may be one of the computer nodes constituting the blockchain network 30.

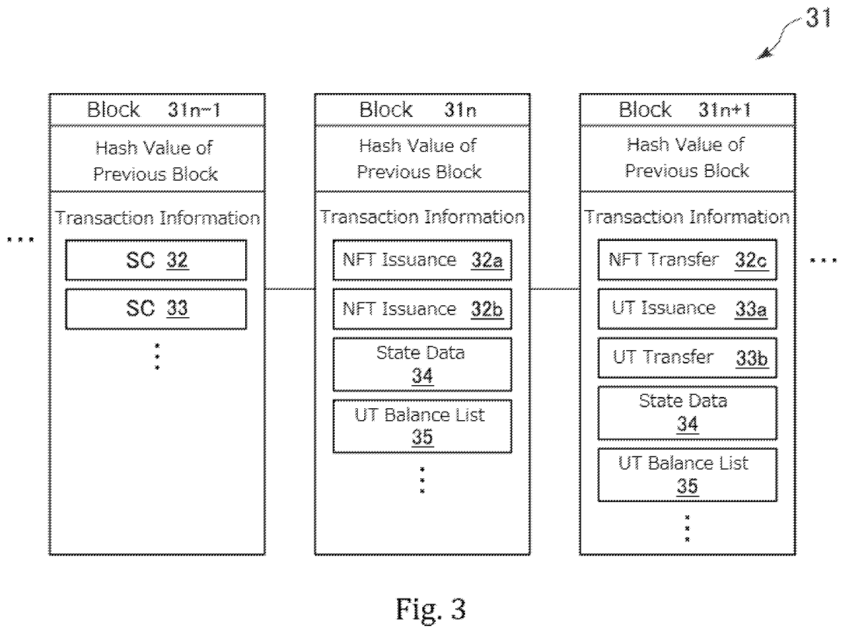

The blockchain retained in the blockchain network 30 will be hereinafter described with reference to FIG. 3. FIG. 3 schematically shows the blockchain 31 used in the video transmission system 1 for issuing tokens, recording transactions, deploying smart contracts, and any other purposes. The blockchain 31 contains multiple blocks. For illustration purposes, FIG. 3 shows three blocks 31n-1, 31n, and 31n+1. The block 31n is the block connected after the block 31n-1, and the block 31n+1 is the block connected after the block 31n.

Each block in the blockchain 31 contains the hash value of the previous block, the hash value of the block itself, and transaction information. Although not shown, each block may contain a “nonce” (number used once) to prevent replay attacks. Each block may contain a time stamp. The hash value of each block can be obtained, for example, by inputting into a hash function the hash value of the previous block, all transaction data contained in the transaction information of the block itself, and the nonce. Because the input to the hash function in each block includes the hash value of the previous block, tampering with a part of the transaction information in the blockchain 31 causes loss of consistency of the hash values within the blockchain 31. Therefore, it is considered virtually impossible to tamper with the transaction information recorded on the blockchain.

The transaction information of each block contains multiple pieces of transaction data. Each piece of transaction data describes the contents of a transaction. The transaction data is transmitted, for example, from the server 20. Specifically, the server 20 encrypts the transaction data with the private key of the operator address information 25e to generate digital signature data, and transmits a transaction including the digital signature data and the transaction data to the blockchain network 30. When the transaction is received, the blockchain network 30 verifies the authenticity of the digital signature data using a known method, for example, a known proof-of-work method. Once the authenticity of the digital signature data is confirmed, the blockchain network 30 records the transaction data associated with the digital signature data into the latest block of the blockchain 31. The transaction data recorded in this block may be stored synchronously in all nodes constituting the blockchain network 30. The transaction data may be transmitted from a wallet, such as the wallet W10a, managed on the server 20 in association with user identification information to the blockchain network 30. The transaction data may be transmitted from a user wallet (e.g., the user wallet W10b) provided on a user device used by the user.

The transaction transmitted from the server 20 may include a deployment request for requesting the deployment of a smart contract (SC) on the blockchain 31. In the example shown in FIG. 3, smart contracts 32, 33 are recorded in the block 31n-1. In other words, the smart contracts 32, 33 are deployed on the blockchain 31.

The smart contract 32 is executed based on a token issuance transaction (e.g., NFT issuance transaction) for issuing a non-fungible token. The NFT issuance transaction may be transmitted from the wallet W10a or from the user wallet W10b. When the smart contract 32 is executed, a non-fungible token is issued to the address of the source of the NFT issuance transaction (e.g., the address corresponding to the operator address information managed by the server 20, the address identified by the public key of the wallet W10a, or the address identified by the public key of the user wallet W10b). The smart contract 32 may be written using the various methods specified in ERC-721. In some embodiments, where the smart contract 32 is written using the methods specified in ERC-721, the execution of the smart contract 32 will result in the issuance of a non-fungible token in accordance with the ERC-721 standard. A non-fungible token issued in accordance with the ERC-721 standard may be referred to as an NFT-721 token. The smart contract 32 may be written in such a way that an NFT can be issued only to the address that deployed the smart contract 32. The smart contract 32 may be written using the various methods specified in ERC-1125 or other standards, instead of ERC-721.

When the smart contract 32 is executed and a non-fungible token is issued, the NFT issuance transaction data describing the transaction for issuing the non-fungible token is recorded in the current block on the blockchain 31. In the example shown in FIG. 3, the NFT issuance transaction data 32a, 32b are recorded in the block 31n.

The blockchain 31 may record state data 34 indicating the latest states of all addresses in the blockchain. The state data describes the latest states of all addresses in the blockchain 31 including the address of the virtual space operator provided by the server 20 and the addresses of wallets (e.g., the wallet W10a) associated with the user identification information of the users managed by the server 20. The state data may include description of the latest state of the address of the user wallet W10b.

The non-fungible token issued by the smart contract 32 to a given address can be transferred to another address. To transfer the non-fungible token from an address A to an address B, an NFT transfer transaction is transmitted from the address A to the blockchain network 30. The NFT transfer transaction includes NFT transfer transaction data that describes the transfer of the non-fungible token from the address A to the address B and digital signature data generated by encrypting the NFT transfer transaction data with the private key of the address A. Once the authenticity of the digital signature data is confirmed in the blockchain network 30, the blockchain network 30 records the NFT transfer transaction data associated with the digital signature data into the latest block of the blockchain 31. In the example shown in FIG. 3, the NFT transfer transaction data 32c is recorded in the block 31n+1. When the NFT transfer transaction data is recorded in the blockchain 31, the state data 34 is also updated to reflect the transfer of the non-fungible token described in the NFT transfer transaction data, and the updated state data 34 may be recorded in the block 31n+1.

The non-fungible token issued on the blockchain 31 can be transferred to an address in a blockchain other than the blockchain 31 that is compatible with the blockchain 31. For example, in the case where the non-fungible token issued on the blockchain 31 is an ERC-721 token, the non-fungible token can be transferred to an address in another blockchain conforming to ERC-721. For example, the non-fungible token can be transferred between wallets that are managed on the server 20 in association with user identification information of the respective users. If the server has an open wallet, the non-fungible token can be traded in the exchange 50 or other marketplaces, and the NFT transfer transaction data describing the transfer made by the trading can be recorded in the blockchain 31.

The smart contract 33 is executed based on a token issuance transaction (e.g., UT (utility token) issuance transaction) transmitted from the server 20 (the address corresponding to the operator address information managed by the server 20). When the smart contract 33 is executed based on the UT issuance transaction, a utility token is issued to the address corresponding to the operator address information managed by the server 20. The smart contract 33 may be written using the various methods specified in ERC-20. For example, the smart contract 33 may specify the total supply of utility tokens. The smart contract 33 manages a balance for each user owning a utility token and, in response to a request from an address, returns to this address the utility token balance for the address. In the case where the smart contract 33 is written using the methods specified in ERC-20, the execution of the smart contract 33 may result in the issuance of an ERC-20 token in accordance with the ERC-20 standard.

The UT issuance transaction for issuing a utility token may be transmitted from the wallet W10a or from the user wallet W10b. For example, each user may be provided with points (e.g., issued points) that can be converted into utility tokens, as will be described later. If these points have been granted to the user A, the user A can convert the points into utility tokens by transmitting from the wallet W10a to the blockchain network 30 a UT issuance transaction for converting the points into utility tokens. The points yet to be converted into utility tokens are not recorded in the blockchain network 30, so they may be treated as off-chain utility tokens in the server 20. For distinction from these off-chain utility tokens, the utility tokens recorded in the blockchain network 30 may be referred to as “on-chain” utility tokens.

When the smart contract 33 is executed and an on-chain utility token is issued, the UT issuance transaction data is recorded in the current block of the blockchain 31. In the example shown in FIG. 3, the UT issuance transaction data 33a is recorded in the block 31n+1. The utility token issued by the smart contract 33 to a given address can be transferred to another address. To transfer the utility token from an address A to an address B, an UT transfer transaction is transmitted from the address A to the blockchain network 30. The UT transfer transaction includes UT transfer transaction data that describes the transfer of the utility token from the address A to the address B. When the smart contract 33 is executed based on the UT transference transaction, a utility token is transferred from the address A to the address B. In the example shown in FIG. 3, the UT transfer transaction data 33b is recorded in the block 31n+1.

The blockchain 31 may retain a UT balance list 35 that records the balance of utility tokens, for each address having a utility token.

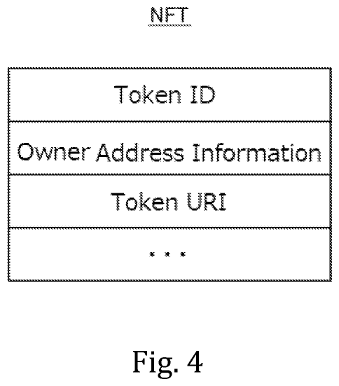

The data structure of the non-fungible token will be hereinafter described with reference to FIG. 4. FIG. 4 schematically shows the data structure of a non-fungible token issued in accordance with the ERC-721 standard. As shown, a non-fungible token (NFT) includes a token ID that identifies the non-fungible token, owner address information indicating the address of the owner of the non-fungible token, and a token uniform resource identifier (URI) indicating the storage location of metadata. The non-fungible token may include data other than those mentioned above.

The token ID is an identifier that uniquely identifies a non-fungible token. A non-fungible token is distinguished from other tokens because it has a token ID associated therewith. In other words, the uniqueness of the token ID associated with the non-fungible token ensures the non-fungible quality of the non-fungible token. The token ID may be an integer that is incremented by “1” for each token issuance request.

The owner address information of the non-fungible token indicates the address of the owner who owns the non-fungible token. The owner address information may be represented by the address (e.g., public key) of the wallet used by the owner of the non-fungible token. If the smart contract 32 specifies only the operator of the virtual space provided by the server 20 as the destination of the issued non-fungible token, then the owner address information of the non-fungible token issued by the smart contract 32 may be set to the address of the operator of the virtual space. The owner address information may also be set to the address represented by the public key of wallet W10a or the address represented by the public key of the user wallet W101b. The “owning” of a non-fungible token by an owner means that this owner is duly recorded as the owner of the non-fungible token in the blockchain network 30, but it does not mean that this owner has any ownership or copyright of a non-fungible asset associated with the non-fungible token. Since a non-fungible asset is an intangible, ownership may not be able to be established in a non-fungible asset depending on the legal jurisdiction. In Japan, for example, ownership is not recognized in intangibles such as data at the time of filing of the present application. In addition, the transfer of copyright related to a non-fungible asset and the establishment of rights of use related to such copyright are treated separately from the transfer of the non-fungible token. Therefore, without a separate (off-chain) agreement, owning a non-fungible token does not in itself mean that an agreement is established to transfer the copyright in the non-fungible asset associated with the non-fungible token.

The token URI is index data that indicates the storage location of the metadata of the non-fungible token. The metadata of the non-fungible token may be written in the NFT issuance transaction data for issuing the non-fungible token. The metadata of the non-fungible token may include a name of the non-fungible token (item name), media, description, target data reference, and other data related to the non-fungible token. The “name (item name)” may represent the name of the non-fungible token. The “name (item name)” may also be identification information (e.g., asset ID) that identifies a non-fungible asset associated with the non-fungible token in the virtual space, identification information that identifies a non-fungible asset associated with the non-fungible token in a game in which the non-fungible asset is used, and/or other character strings that identify a non-fungible asset associated with the non-fungible token. The “media” may represent the file type of the data associated with the non-fungible token. The data associated with a non-fungible token may be herein referred to as “target data.” Examples of “media” are JPG, GIF, and other file types. The “description” may be a description of the target data. In the case where the target data is an object of glasses worn by an avatar in a virtual space, the “description” may say, for example, “In 2022, produced in a limited quantity of 100 pairs.” The “description” may be set as appropriate in the NFT issuance transaction data within the text limit. The target data reference is data that identifies the storage location of the target data, where one example thereof is a URL.

The metadata of a non-fungible token may be stored in the file system 40. The metadata of the non-fungible token may be stored on a storage other than the file system 40 that is accessible to the user devices 10a, 10b, the server 20, and the blockchain network 30. The metadata of the non-fungible token may be recorded in the blockchain 31 as a portion of the non-fungible token.

The target data associated with a non-fungible token is a digital asset used in a virtual space provided by the server 20, and examples of the target data include an object or an avatar placed within the virtual space. The target data associated with a non-fungible token may be stored on the server 20 for use in the virtual space. A backup of the target data may be stored in the file system 40. The target data reference included in the metadata may be a URL that identifies the storage location of the target data within the file system 40.

In some embodiments, of the data related to a non-fungible token, only a part of the data set such as the token ID, the owner address information, and the token URI is recorded in the blockchain 31, and the metadata and the target data are not recorded in the blockchain 31 but may be recorded in the file system 40. Of the data related to a non-fungible token, the data set recorded in the blockchain 31 may be referred to as index data of the non-fungible token. Recording a non-fungible token in the blockchain 31 may mean recording only a part of the non-fungible token, or specifically, only the index data. In other words, when the index data of a non-fungible token is recorded in the blockchain 31, the non-fungible token can be regarded as being recorded in the blockchain 31.

In some embodiments, the metadata of a non-fungible token and the target data associated with the non-fungible token may be recorded in the blockchain 31. Such a method in which not only the index data but also the metadata and the target data are recorded in the blockchain may be referred to as “full on-chain,” because the entirety of the non-fungible token is recorded in the blockchain. The non-fungible token used in the video transmission system 1 may be recorded in the blockchain 31 fully on-chain.

Blockchains other than Blockchain 31 may be used to issue a non-fungible token or a utility token for use in the video transmission system 1. A virtual space operator may select an appropriate blockchain, such as based on the gas fees and the speed of transactions.

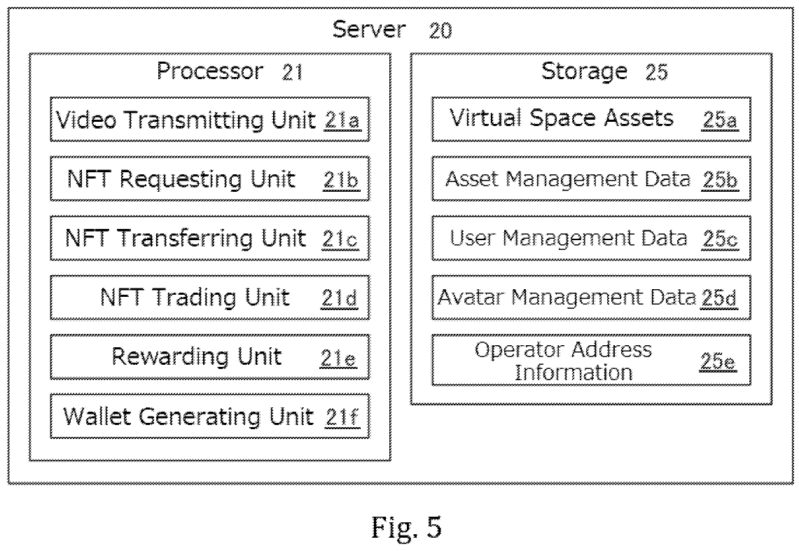

The following describes the functions of the server 20 and the data stored on the server 20 with reference to FIG. 5.

The server 20 includes a processor 21 and storage 25. Although not shown, the server 20 may include one or more memory, an input interface for receiving user input, an output interface for outputting information, a communication interface, and other components. The processor 21 is a computing device which loads an operating system or other various programs from the storage 25 or other storage into the memory and executes instructions included in the loaded programs. The processor 21 is, for example, a CPU, an MPU, a DSP, a GPU, any other computing device, or a combination thereof. The storage 25 is an external storage device accessed by the processor 11. The storage 25 is, for example, a magnetic disk, an optical disk, a semiconductor memory, or various other storage devices capable of storing data.

The storage 25 stores virtual space assets 25a, asset management data 25b, user management data 25c, avatar management data 25d, and operator address information 25e. The storage 25 may store data other than those mentioned above.

The virtual space assets 25a are digital assets used in the virtual space provided by the server 20. The virtual space assets 25a are used to construct the virtual space. The virtual space assets 25a may include avatar display data for displaying avatars of users, structure data representing buildings, furniture, and other structures to be placed in the virtual space, and various other data used to construct the virtual space. The virtual space assets 25a may include object location information indicating the positions of objects in the virtual space. A position in the virtual space may be designated by coordinate values in a three-dimensional global coordinate system defined in the virtual space. The virtual space assets 25a may include object identification information that identifies, within the virtual space, the objects used to construct the virtual space and/or the objects used in the virtual space.

The avatar display data is information used to display avatars in the video. The avatar display data may include part data representing images of parts constituting the avatar, for example, the head, hair style, facial parts (eyes, nose, mouth and so on), trunk, and the like.

The avatar display data may include wearable item data representing wearable items that can be worn by avatars in the virtual space. The wearable items are objects that are associated with specific parts of the avatars in the virtual space. The wearable items are objects that can be worn by avatars, for example, an accessory (such as a headband, a necklace, an earring, etc.), clothes (such as a T-shirt, a hoodie, a skirt), a costume, and any other objects which can be worn by the avatars. The wearable item data may include wearing position information indicating which part of an avatar is associated with a wearable item.

The virtual space assets 25a may include gift object data representing gift objects used as digital gifts that can be gifted between users. The gift objects may resemble stuffed animals, bouquets of flowers, bags, or accessories. The gift objects may be wearable items worn by the avatars. A user can gift other users with wearable items that represent accessories to be worn by their avatars in the virtual space. Digital assets that can be gifted to other users are not limited to those mentioned above. Various digital assets (objects representing furniture, blocks, avatar parts, etc.) used in the virtual space provided by the server 20 may be gifted between users.

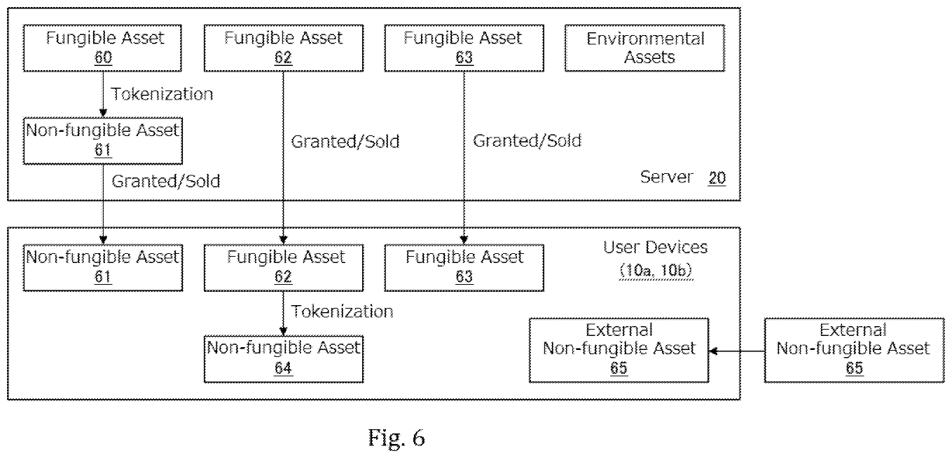

The virtual space assets 25a will be further described with reference to FIG. 6. The virtual space assets 25a may include user assets, which are granted to users, and environmental assets, which are used exclusively by the virtual space operator. One example of the user assets is the avatar display data described above. A user can obtain avatar display data and create an avatar according to his/her own personalities based on the avatar display data obtained. The user may also obtain structure data and place a preferred structure in the virtual space based on the structure data obtained. The user assets may be voxel-based blocks. For example, the user can obtain structure data representing brick blocks in the virtual space and place the brick blocks at desired locations in the virtual space to create a house exterior. The environmental assets may be data representing, for example, the ground and terrain that correspond to the infrastructure of the virtual space. However, land parcel data regarding parcels of land may be user assets. The land parcel data may be data that designates a parcel in the virtual space using coordinates in the virtual space. Such land parcel data may be tokenized as NFTs, and the NFTs corresponding to the land parcel data may be granted or sold to the user.

The user assets include fungible assets and non-fungible assets. In FIG. 6, fungible assets 60, 62, 63 and non-fungible assets 61, 64 are shown as examples of user assets. The non-fungible assets can include native non-fungible assets and converted non-fungible assets. The native non-fungible assets have been tokenized as NFTs before being granted or sold to a user, and the converted non-fungible assets have been granted to a user before being tokenized as NFTs in response to a minting request from the user.

The fungible assets are assets that have not been tokenized as non-fungible tokens by the blockchain network 30 or a blockchain network other than the blockchain network 30. Whether a user asset is a fungible asset or a non-fungible asset is determined, for example, by referring to asset management data 25b described later. The user can acquire fungible assets in the video transmission service provided by the server 20 and use the acquired fungible assets in the virtual space provided by the server 20. The fungible assets may not be able to be traded outside the video transmission system 1. Trading of the fungible assets outside the video transmission system 1 may be prohibited in the user agreement that the user agrees to when receiving the video transmission service provided by the server 20. One example of the fungible assets that can be acquired by a user is a wearable item that represents a T-shirt to be worn by his/her avatar. The user can use the acquired wearable item in the virtual space operated by the server 20. For example, the user can have the wearable item worn by his/her avatar in the virtual space. In some embodiments, the user cannot use or trade the acquired wearable item (fungible asset) outside the video transmission system 1.

The use of fungible assets in the virtual space may include giving the fungible assets to other users, exchanging the fungible assets for other user assets owned by other users, and discarding the fungible assets. Trading of the fungible assets may be prohibited outside the video transmission system 1, but it may be permitted within the video transmission system 1.

As with the fungible assets, the non-fungible assets are also used in the virtual space. In some embodiments, non-fungible tokens associated with the non-fungible assets can be traded even outside the video transmission system 1. Trading of non-fungible tokens may be conducted in a marketplace outside the video transmission system 1. In the marketplace, the non-fungible tokens may be sold at prices specified by the user or sold in an auction style. A virtual currency, such as Ether, may be used as the transaction currency (e.g., transaction token) for buying and selling the non-fungible tokens. The non-fungible tokens may be traded in a known marketplace such as OpenSea. A predetermined fee may be paid to the operator of the server 20 (the virtual space operator) for the transfer of a non-fungible token to another address. The fee required for the transfer of a non-fungible token can be written in the smart contract that issues the non-fungible token. When a non-fungible token is transferred between users of the services provided by the server 20 using an internal marketplace of the server 20, the transfer fee may be negligible (e.g., free). In some embodiments, the smart contract may be written such that the transfer fee is paid only when a non-fungible token associated with a non-fungible asset that can be used in the virtual space provided by the server 20 is traded outside the server 20 (e.g., in an external marketplace such as OpenSea). The transfer fee for non-fungible tokens may be collected at each transfer or only at the initial transfer. The transfer fee may be paid in on-chain or off-chain utility tokens.

A part of the virtual space provided by the server 20 may be a closed space open only to avatars meeting the admission requirement. The closed space may be a virtual live venue or party venue set up within the virtual space, or other partitioned areas within the virtual space. The admission requirement may be, for example, that the user owns a specific non-fungible asset associated with the closed space. A specific non-fungible asset that needs to be owned by a user for admission to the closed space may be referred to herein as a “non-fungible asset for admission.” In some embodiments, the non-fungible asset for admission that a user needs to own for admission to the closed space is a native non-fungible asset (e.g., the non-fungible asset 61). In another embodiment, the non-fungible asset for admission is a converted non-fungible asset (e.g., the non-fungible asset 64). The non-fungible asset for admission may be at least one of the native non-fungible asset and the converted non-fungible asset. In some embodiments, multiple non-fungible assets may be required for admission. For example, it is also possible that the requirement for admission to the closed space is that the user owns both a native non-fungible asset and a converted non-fungible asset.

In some embodiments, when a closed space is set up, non-fungible tokens associated with the closed space (hereinafter referred to as “admission ticket tokens”) may be issued, and only the avatars of the users owning the ticket token may be admitted to the closed space. The number of ticket tokens issued can be adjusted to limit the number of avatars admitted to the closed space.

In some embodiments, a user may be able to set up a closed space within the virtual space. For convenience, the user who sets up a closed space is referred to as an organizer user. The organizer user may, for example, designate a section of the virtual space as a closed space and request the blockchain network 30 to issue non-fungible tokens (admission ticket tokens) associated with the closed space. The organizer user may sell the admission ticket tokens in the marketplace. The operator of the server 20 (the virtual space operator) may collect a price for setting up a closed space from the organizer user. The price for setting up a closed space may be paid in on-chain or off-chain utility tokens. The organizer user may have to pay a price to set up a closed space and have to pay a gas fee to issue ticket tokens, but the organizer user may be able to generate revenue by selling the admission ticket tokens.

A user can acquire fungible assets and non-fungible assets in a variety of ways. For example, a fungible asset and/or a non-fungible asset may be granted to a user as a login bonus when the user logs in to the video transmission service provided by the server 20. A user, who has logged in, may visit an item purchase screen and purchase an item displayed on the item purchase screen.

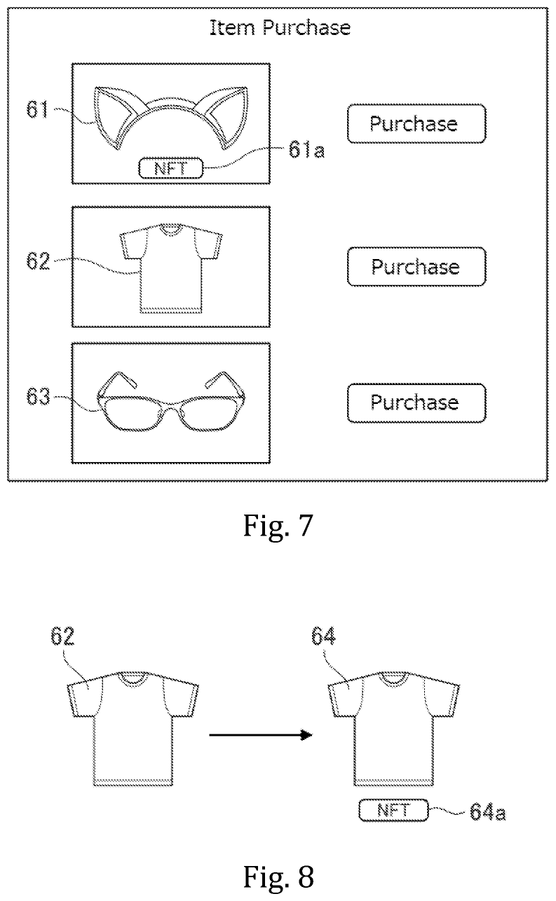

FIG. 7 shows an example of an item purchase screen for a user to purchase user assets. The item purchase screen appears on the display of the user device (e.g., the user device 10a). The user can purchase a desired user asset from the item purchase screen via the user device 10a. The item purchase screen shown in FIG. 7 contains images representing three items, namely items 61, 62, 63. The item 61 is an example of a native non-fungible asset, and the items 62, 63 are examples of fungible assets. An NFT mark 61a is shown near the image representing the item 61. The NFT mark 61a is an example of an indication element that indicates that the item 61 is a non-fungible asset. The items 62, 63 are not non-fungible assets (e.g., these are fungible assets), and thus they do not have an NFT mark associated therewith. The price for purchasing an item may be paid in legal tender, points granted to the user within the service provided by the server 20, utility tokens, or crypto assets.

After acquiring (e.g., purchasing) a fungible asset, the user may tokenize the fungible asset as an NFT via the user device 10a. For example, the user A can send a tokenization request to the server 20 to tokenize the fungible asset as an NFT. Upon receipt of the tokenization request, the server 20 transmits to the blockchain network 30 transaction data (NFT issuance transaction data) for tokenizing the fungible asset as a non-fungible token. After verification of the transaction data in the blockchain network 30, an NFT generated by tokenizing the fungible asset is issued to the address from which the NFT issuance transaction data was transmitted. For example, in the case where an NFT is issued based on transaction data transmitted from the wallet W10a associated with the user A, the owner address information of this NFT is set to the address of the wallet W10a represented by the public key of the wallet W10a. The NFT issuance transaction data for tokenizing the fungible asset as an NFT may be transmitted from a user device having a user wallet (e.g., the user device 10b) to the blockchain network 30. In this case, the NFT generated by tokenizing the fungible asset is issued to the address of the wallet provided on the user device that transmitted the NFT issuance transaction data. In this way, the fungible asset is tokenized as the NFT. The fungible asset may be tokenized as the NFT after the transfer between users of the services provided by the server 20. For example, the user A purchases a fungible asset from the virtual space operator and assigns the fungible asset to the user B, and then the user B may tokenize the fungible asset as an NFT. In this case, the NFT issuance transaction data may be transmitted from the user wallet W10b of the user B to the blockchain network 30. If the smart contract 32 limits the destination of the issued non-fungible token to the virtual space operator, the NFT associated with the converted non-fungible asset 64 may be issued to the virtual space operator and then transferred to the address of the user who made the tokenization request.

As shown in FIG. 8, when the fungible asset 62 is tokenized as an NFT, the fungible asset 62 is converted to the non-fungible asset 64. The non-fungible asset 64 is an example of a converted non-fungible asset. When the non-fungible asset 64 is displayed on the user device in at least some instances, an NFT mark 64a is displayed near the non-fungible asset 64. The non-fungible asset 64 has the same appearance as the fungible asset 62, but the NFT mark 64a appears close to or superimposed on the non-fungible asset 64, and thus the non-fungible asset 64 can be distinguished from the fungible asset 62 by their appearances. The NFT mark 64a displayed to distinguish the converted non-fungible asset 64 may have a different appearance than the NFT mark 61a displayed to distinguish the native non-fungible asset 61. For example, the NFT mark 64a displayed to distinguish the converted non-fungible asset 64 may have a different shape and/or color or include a different character string than the NFT mark 61a displayed to distinguish the native non-fungible asset 61. This allows the user to distinguish whether a non-fungible asset is a native non-fungible asset or a converted non-fungible asset with reference to the NFT mark displayed near the non-fungible asset.

In the virtual space provided by the server 20, it may be possible to use a non-fungible asset created and tokenized as an NFT outside the video transmission system 1 (e.g., in a service other than the services provided by the server 20). FIG. 6 shows an external non-fungible asset 65 as an example of a non-fungible asset created outside the video transmission system 1. As with the non-fungible assets 61, 64, the external non-fungible asset 65 may be an ERC-721 token. For example, a user of the services provided by the server 20 can use a user wallet conforming to ERC-721 to purchase an external non-fungible asset 65 sold in an external marketplace and transfer the NFT associated with the external non-fungible asset 65 to himself/herself. A user of the video transmission system 1 can thus use, in the virtual space provided by the server 20, the non-fungible asset acquired in an external marketplace.

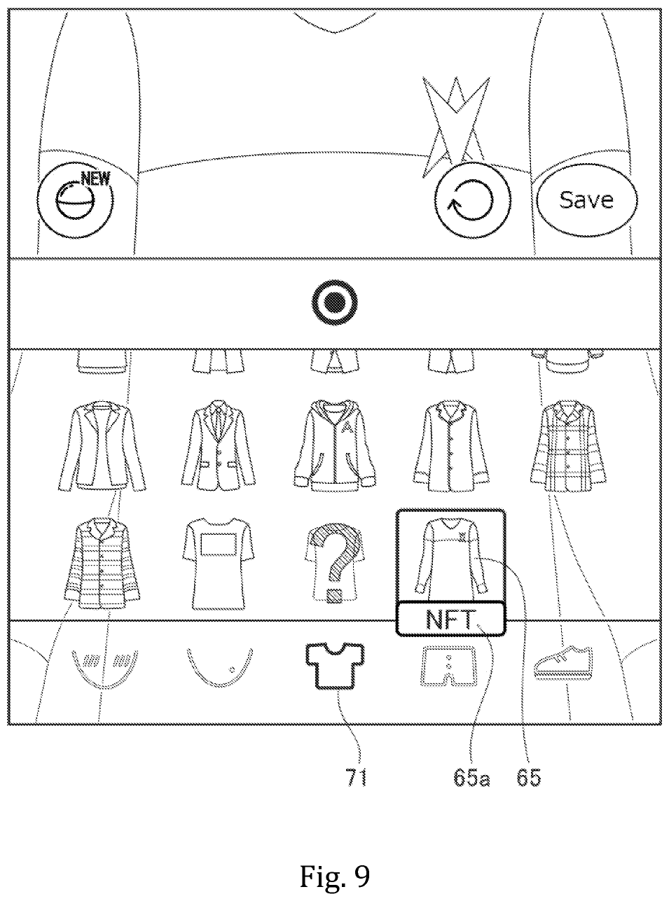

With reference to FIG. 9, the following describes an example of use by the user using the external non-fungible asset 65 in the virtual space. FIG. 9 is an example of a dress-up screen for an avatar. The dress-up screen for an avatar is displayed on the user device (e.g., the user devices 10a, 10b) in response to the user's operation on the user device. For example, the dress-up screen may be displayed on the user device when a selection button 71, which appears at the bottom of the screen after login, is selected by the user. In the dress-up screen, a list of wearable items owned by the user is displayed. The external non-fungible asset 65 is also included in this list and displayed on the dress-up screen. An NFT mark 65a is also displayed near the icon of the external non-fungible asset 65 to indicate that the external non-fungible asset 65 has been tokenized as an NFT.

When the external non-fungible asset 65 is selected by the user on this dress-up screen, the avatar of the user can wear the external non-fungible asset 65. In response to the selection of external non-fungible asset 65 by the user, the server 20 may confirm whether or not the user owns the NFT associated with the external non-fungible asset 65. The smart contract that issued the NFT associated with the external non-fungible asset 65 may include a function for returning the owner address information of an issued NFT in response to a request, in addition to the function for issuing an NFT. The server 20 can confirm the owner of the external non-fungible asset 65 by accessing the smart contract that issued the NFT associated with the external non-fungible asset 65. For example, suppose that the external non-fungible asset 65 is selected by a user. Only if the user who selected the external non-fungible asset 65 corresponds to the owner of the NFT associated with the external non-fungible asset 65, the server 20 may permit use of the external non-fungible asset 65. Otherwise, the server 20 may not permit the user to use the external non-fungible asset 65.

The server 20 may confirm whether or not the external non-fungible asset 65 is a digital asset that can be used in the service provided by the server 20. For example, only if the server 20 confirmed that the external non-fungible asset 65 can be used, the server 20 may permit use of it in the virtual space provided by the server 20. For example, the server 20 may verify whether or not the smart contract that issued the non-fungible token associated with the external non-fungible asset 65 is the same as the smart contract (e.g., the smart contact 32) for tokenizing as an NFT the digital assets used in the virtual space provided by the server 20. If the server 20 confirmed that they are the same, the server 20 may permit use of the external non-fungible asset 65 in the virtual space provided by the server 20. In another aspect, the server may verify whether or not the asset ID included in the metadata of the NFT associated with the external non-fungible asset 65 is the same as the asset ID assigned to a digital asset provided by the server 20. If the server 20 confirmed that they are the same, the server 20 may permit use of the external non-fungible asset 65 in the virtual space provided by the server 20. Asset IDs will be described later.

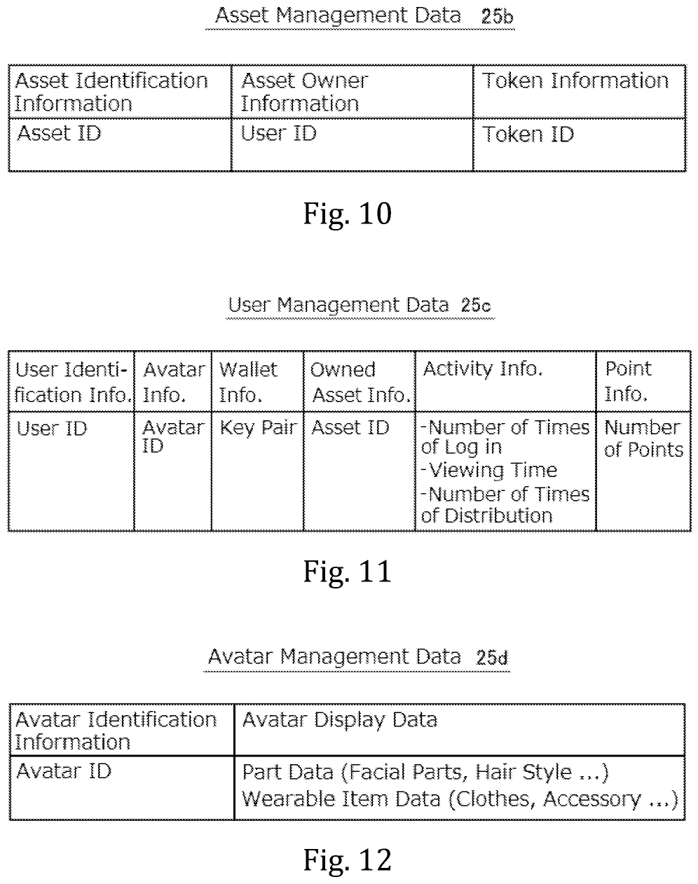

The following describes the asset management data 25b with reference to FIG. 10. The asset management data 25b is a data set that structurally stores data for managing user assets. The asset management data 25b includes asset identification information that identifies a user asset, asset owner information that identifies the owner of the user asset in the virtual space, and token information that identifies the non-fungible token associated with the user asset.

The asset identification information of a user asset is, for example, an asset ID that identifies the user asset. An asset ID uniquely identifies a user asset in the video transmission system 1. An asset ID is assigned to user assets by the virtual space operator before the user assets are distributed in the virtual space.

The asset owner information of a user asset is, for example, the user ID of the user who owns the user asset in the virtual space provided by the server 20. Since the asset ID that identifies a user asset and the user ID of the user who owns the user asset are stored in association with each other, it is possible to identify the user owning a user asset. The asset owner information for user assets that are not owned by any user may be set to a null value. The asset owner information for a user asset is not data that indicates the owner of an NFT in the blockchain network 30 but data that identifies the user authorized to own the user asset in the virtual space. For example, suppose that the user A purchases the non-fungible asset 61, for example, through the item purchase screen shown in FIG. 7. The user ID of the user A is associated with the asset ID of the non-fungible asset 61 and stored as a portion of the asset management data 25b.

The token information of a user asset is, for example, the token ID that identifies the non-fungible token associated with the user asset. If the user asset is a non-fungible asset, the token ID of the NFT associated with the non-fungible asset may be stored as the token information of the user asset. If the user asset is a fungible asset, no token ID is associated with the user asset, and thus the token information of the user asset may be set to a null value. Since the asset ID that identifies a user asset and the token ID associated with the user asset are stored in association with each other, it is possible to determine whether the user asset is a non-fungible asset or a fungible asset. If the user asset is a non-fungible asset, it is possible to identify the non-fungible token associated with the user asset.

The following describes the user management data 25c with reference to FIG. 11. The user management data 25c includes user identification information of each user of the video transmission system 1, avatar information on the avatar used by the user, owned asset information for identifying a user asset owned by the user, activity information indicating an activity of the user in the virtual space, wallet information on the wallet hosted by the server 20, and point information on the points owned by the user.

The user identification information of a user is, for example, a user ID identifying the user. The user ID of a user may be issued when the user signs up for the video transmission service provided by the server 20 through the user device (e.g., the user device 10a). This video transmission service allows the user to view video data transmitted from the server 20 or a video generated from the video data.

The avatar information of a user is, for example, an avatar ID identifying the avatar used by the user in the video transmission system 1. The avatar ID may be assigned to the user when the user registers an avatar. In the example shown in FIG. 2, the user A is using the virtual space through the avatar 70a. In this example, the avatar ID of the avatar 70a is stored as a portion of the user management data 25c in association with the user ID of the user A. The avatar is registered after (or at the same time as) signing up for the video transmission service in the video transmission system 1. When registering an avatar, the user can select favorite parts from the part data to make up the avatar with the selected parts. Each of the parts that make up the avatar may be stored in association with a part ID identifying the part as a portion of the user management data 25c or as a portion of a separate data set. If an avatar is made of multiple parts, the part IDs identifying the multiple parts making up the avatar may be stored in association with the avatar ID identifying the avatar. Even after the avatar is registered, the user may change some or all of the parts of the avatar. For example, even after registering the avatar, the user can change the hair style, facial parts, and any other parts constituting the avatar. The user can also select wearable item data, such as clothing to be worn by the avatar, and have the avatar wear the wearable item corresponding to the selected wearable item data in the virtual space. The avatar information may be coordination information that identifies a combination of digital assets (hairstyles, parts, clothing, accessories, etc.) that determine the appearance of the avatar. Multiple coordination information may be stored for each user. The user can set the appearance of the avatar by specifying the coordination without having to individually select hairstyles, parts, clothing, etc. Thus, the user can set and also switch the appearance of the avatar by specifying the coordination information.

As shown in FIG. 12, the part data and the wearable item data selected for an avatar may be stored on the storage 25 as the avatar management data 25d.

The avatar display data may include 2D display information for displaying the avatar two-dimensionally in the video and 3D display information for displaying the avatar three-dimensionally in the video. The 3D display information for displaying the avatar three-dimensionally includes the part data indicating the images of the parts for displaying the avatar three-dimensionally in the video, and in addition, rig data for representing the three-dimensional motion of the avatar, and any other known information used to display the avatar three-dimensionally.

The wallet information for each user includes information on a wallet that can be used by the user within the services provided by the server 20 and may be hosted by the server 20. The wallet information associated with the user identification information of a user includes, for example, a wallet ID that identifies the wallet, the public key of the wallet used by the user, and the private key that is paired with this public key. If the user does not use the wallet hosted by the server 20, the wallet information may contain a null value. The user may use a wallet provided on his/her own user device (e.g., the user wallet W10b), instead of a wallet hosted by the server 20, to trade non-fungible tokens within the services provided by the server 20 or use on-chain utility tokens. If the user uses the wallet provided on his/her own user device and does not use the wallet hosted by the server 20, the wallet information may contain the identification information that identifies the wallet provided on the user device. For example, the wallet information of a user may contain the public key of the key pair used by the wallet provided on the user device of the user. For a specific example, the user management data 25c may store the identification information that identifies the user wallet W10b provided on the user device 10b of the user B (e.g., the public key used by the user wallet W10b) in association with the user ID of the user B. If the user uses the wallet provided on his/her own user device and does not use the wallet hosted by the server 20, the wallet information associated with the user identification information of the user may contain a null value. In some embodiments, it is also possible that a user uses the services provided by the server 20 without using non-fungible tokens or on-chain utility tokens. The wallet information associated with the user identification information of such a user who do not use non-fungible tokens may contain a null value.

The owned asset information of each user is information on the user assets owned by the user. The owned asset information of a user is, for example, the asset ID of a user asset owned by the user. Since the user ID that identifies a user and the asset ID that identifies a user asset owned by the user are stored in association with each other, it is possible to identify the user asset owned by the user. Since the asset management data 25b stores the asset IDs of the user assets and the user IDs of the users owning the user assets in association with each other, the user management data 25c may not include the owned asset information.

When the server 20 receives a request from one user to view the owned asset information of another user, the server 20 may create a list of user assets owned by the other user with reference to the owned asset information of the other user and transmit the owned asset list to the user device of the one user. The owned asset list of a user includes information on all or some of the user assets owned by the user. In some embodiments, the owned asset list of a user may only include non-fungible assets owned by the user. The owned asset list of a user may include, in association with the name of each of the one or more user assets owned by the user, for example, an icon indicating the user asset, fungibility information indicating whether the user asset is a fungible asset or a non-fungible asset, native identification information for a non-fungible asset indicating whether the non-fungible asset is a native non-fungible asset or a converted non-fungible asset, and any other information on the user asset owned by the user. When the owned asset list of the other user is transmitted from the server 20 to the user device of the one user in response to the request from the one user, the information contained in the owned asset list may be displayed on the display of the user device of the one user. This allows the one user to identify the user assets owned by the other user. In addition, if the owned asset list includes the fungibility information, the one user can identify the non-fungible assets owned by the other user.

The activity information of each user may include various information indicating activities of the user in the virtual space. The following are examples of activity information of a user.

### (Examples of Activity Information)

The duration and/or the number of times for which the user has logged in to the video transmission service provided by the server 20.
The number of other users registered as friends by the user (e.g., the number of friends).
The number of other users followed by the user (e.g., the number of followed users).
The number of other users following the user (e.g., the number of followers).
The sum of coins given by the user to other users.
The number of gifts given by the user to other users in videos distributed by the other users.
The number of comments sent by the user in videos distributed by other users.
The number of positive feedbacks (e.g., the number of “likes”) the user has given to videos distributed by other users.
The sum of coins the user has received from other users.
The viewing time and/or the number of times for which the user has viewed the videos provided by the video transmission system 1.
The duration and the number of times for which the user has distributed videos in the video transmission system 1 and/or the number of viewers of such videos.
The rank of the user in the various rankings managed by the video transmission system 1.
The class of the user (e.g., divided into S, A, B, and C ranks) managed by the video transmission system 1.
The number of times for which the user has visited rooms, worlds, live venues, or other distinct sections in the virtual space.
The number of objects created by the user that can be placed in the virtual space (e.g., the number of created objects).
The number of objects created by the user and placed in the virtual space (e.g., the number of placed objects).
The number of contents (e.g., user generated content (UGC)) in the virtual space created by the user (e.g., the number of created UGC).
The number of worlds (instances of virtual space created from virtual space templates) customized by the user.
The number of games created by the user (e.g., the number of created games).
The number of live shows or events organized by the user (e.g., the number of organized events).
The number of times for which the user has participated in events organized by other users (e.g., the number of times of participating in events).
The purchase amount of an event ticket purchased by the user to participate in a specific event in the virtual space (e.g., purchase amount).
The number of user assets owned by the user (e.g., the number of assets).
The purchase amount of gacha purchased by the user in the case where paid gacha is provided in the video transmission service provided by the server 20.
Other indexes that represent the activeness of the user in the virtual space.
The number of times and/or the duration for which the user has used a text chat function.
The number of times and/or the duration for which the user has used a video chat function.
Other indexes that represent the activeness of the user in the video transmission service provided by the server 20.

In video transmission system 1, points may be issued to users. The point information for each user represents the number of points owned by each user. The points in the video transmission system 1 are granted, for example, in accordance with the number of times of logging in to the video transmission service, the viewing time for videos, the number of times of viewing videos, and other activities in the video transmission system 1. The point information may be included in the activity information.

The following describes the functions performed by the processor 21 of the server 20, as depicted in FIG. 5. The computer processor 21 may function as a video transmitting unit 21a by executing computer-readable instructions included in a program stored on the storage 25.

The server 20 can transmit various types of videos. It is hereinafter assumed that in an illustrative example the server 20 transmits video data of a video for which the user A is the distributor (hereinafter referred to as “the distributed video of the user A”), and the user B views the distributed video of the user A on the user device 10b. As already described, generation of the video from the video data may be performed by any of the devices in the video transmission system 1. The distributed video of the user A is generated by any of the server rendering method, the client rendering method, or the browser rendering method. Different rendering methods may be used for different user devices. For example, the user device 10a may play the distributed video of the user A generated by the client rendering method, while the user device 10b may play the distributed video of the user A generated by the server rendering method.

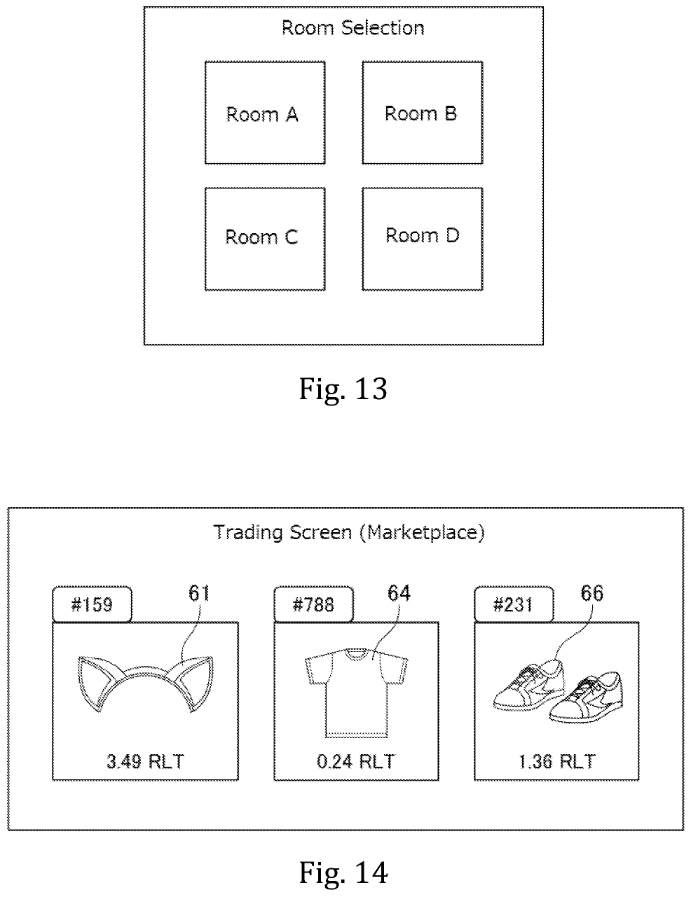

When the user A logs in, the video transmitting unit 21a refers to the user management data 25c to identify the avatar ID associated with the user ID of the user A, and generates the avatar 70a of the user A based on the avatar display data associated with the avatar ID of the user A. The avatar 70a of the user A is displayed in the virtual space, as shown in FIG. 2, for example. When the virtual space containing the avatar 70a of the user A is generated and a distribution request for a video is sent from the user A to the server 2, a room selection screen including “Room A” for viewing the video containing a view of the virtual space including the avatar of the user A is displayed on the user devices of the user who has logged in to the video transmission service for viewing videos. For example, the user B logs in to the video transmission service using the user device 10b and selects a video viewing button on the home screen displayed on the user device 10b to view a video. The user device displays the room selection screen for selecting a video to be viewed. An example of the room selection screen is shown in FIG. 13. As shown in FIG. 13, the room selection screen contains Room A for viewing the distributed video of the user A, as well as Rooms B to D. When the user B operates the user device 10b to select room A, the user device 10b plays the distributed video of the user A including the avatar of the user A. While viewing the distributed video of the user A, the user B can interact with the user A through the text chat function or the video chat function, give a gift object to the user A, give coins to the user A, or provide feedback to the user A.

Some of the rooms displayed on the room selection screen (e.g., Rooms A to D) may be selectable only when a condition for viewing is satisfied. The condition for viewing may be, for example, that the user who wishes to view the video (in the above example, the user B) owns at least one non-fungible asset.

The video transmitting unit 21a may transmit video data by methods other than that described above. For example, the video transmitting unit 21a can transmit, to the user device of a user who has signed in to the service provided by the server 20, video data of a video that includes a view of the virtual space taken by a virtual camera installed in the virtual space. This allows the user to view the video that includes the view of the virtual space, instead of a distributed video from a specific distributor user.

The processor 21 can perform various functions in addition to its function as the video transmitting unit 21a. For example, the processor 21 can function as an NFT requesting unit 21b, an NFT transferring unit 21c, an NFT trading unit 21d, a rewarding unit 21e, and a wallet generating unit 21f, by executing computer-readable instructions contained in a program stored on the storage 25.

The NFT requesting unit 21b generates the NFT issuance transaction data for a fungible asset. For example, as shown in FIG. 6, the fungible asset 60 is tokenized as an NFT before being granted to a user. In some embodiments, in order to tokenize the fungible asset 60 as an NFT, the NFT requesting unit 21b stores the backup data of the fungible asset 60 in the file system 40. In some embodiments, the NFT requesting unit 21b transmits to the blockchain network 30 transaction data for tokenizing the fungible asset as a non-fungible token (the NFT issuance transaction data). In the blockchain network 30, the smart contract 32 may be executed based on the NFT issuance transaction data. Upon execution of the smart contract 32, the fungible asset 60 is tokenized as an NFT and turns into the non-fungible asset 61, and the NFT having the token ID associated with the non-fungible asset 61 is issued to the address of the virtual space operator. The transaction for issuing this NFT is recorded into the latest block of the blockchain 31. In addition, the NFT requesting unit 21b may store the token ID of the issued NFT on the storage 25 as a portion of the asset management data 25b in association with the asset ID of the non-fungible asset 61.

The NFT requesting unit 21b may tokenize a fungible asset as an NFT in response to a request from a user owning the fungible asset. The request from a user for tokenizing a fungible asset as an NFT may be herein referred to as a “tokenization request” or a “minting request.” For example, as shown in FIG. 6, if a user owns the fungible asset 62, the user can operate the user device to send a tokenization request to the server 20 for requesting tokenization of the fungible asset 62 as an NFT. In some embodiments, when the server 20 receives the tokenization request, the NFT requesting unit 21b tokenizes the fungible asset 62 by storing the backup data of the fungible asset 62 in the file system 40 and transmitting to the blockchain network 30 the transaction data (the NFT issuance transaction data) for tokenizing a fungible asset as a non-fungible token. Upon execution of the smart contract 32 based on the NFT issuance transaction data, the fungible asset 62 is tokenized as an NFT and turns into the non-fungible asset 64, and the NFT having the token ID associated with the non-fungible asset 64 is issued. This NFT may be issued to the address of a wallet (e.g., the wallet W10a) hosted by the server 20 in association with the user identification information of the user who made the tokenization request. The transaction for issuing this NFT is recorded into the latest block of the blockchain 31. In addition, the NFT requesting unit 21b may store the token ID of the issued NFT on the storage 25 as a portion of the asset management data 25b in association with the asset ID of the non-fungible asset 64.

An NFT may be generated either for one fungible asset or for a set of multiple fungible assets. For example, a set of wearable items coordinated together to be worn by an avatar may be tokenized as an NFT. In this case, one non-fungible token is issued for the set of multiple wearable items. The set of multiple wearable items constitutes the target data associated with the issued non-fungible token.

When a set of multiple fungible assets are tokenized as an NFT, the set of fungible assets tokenized as an NFT is referred to as set data. A user may select multiple fungible assets that constitute the set data from the items that he/she owns. The set data may be a combination of multiple parts of an avatar. For example, the set data may be a combination of specific facial parts and specific hairstyle parts of an avatar. As described above, the storage 25 may store, in association with the avatar ID of the avatar used by the user, coordination information that identifies a combination of digital assets (hairstyles, parts, clothing, accessories, etc.) that determine the appearance of the avatar. The combination of digital assets that make up this coordination information may be set data. If the avatar of a user participates in a particular event held in the virtual space, the user may specify as set data a combination of digital assets (hairstyles, parts, clothing, accessories, etc.) that determine the appearance of the avatar participating in that event. A user may specify, for example, an event in the virtual space in which the user participated via an avatar, to select as set data the combination of digital assets that determined the appearance of the avatar of the user in that event, and tokenize the selected set data as an NFT.

The NFT transferring unit 21c performs a process for transferring an NFT from a source address to a destination address. For example, if the user A assigns the non-fungible asset 61 to the user B, the NFT transferring unit 21c generates NFT transfer transaction data for transferring the NFT associated with the non-fungible asset 61 from the address of the user A to the address of the user B. The NFT transfer transaction data describes transfer of the NFT associated with the non-fungible asset 61 from the address of the wallet W10a of the user A to the address of the wallet W10b of the user B. The NFT transfer transaction data is encrypted with the private key of the wallet W10a of the user A hosted by the server 20 to generate digital signature data. The NFT transfer transaction data is transmitted from the server 20 to the blockchain network 30 along with the generated digital signature data. Once the authenticity of the digital signature data is confirmed in the blockchain network 30, the blockchain network 30 records the NFT transfer transaction data associated with the digital signature data into the latest block of the blockchain 31.

The NFT transferring unit 21c may receive an NFT transfer request from an address other than those of users of the services provided by the server 20. If the NFT transfer request is transmitted from an address on a blockchain network compatible with the blockchain network 30, then the NFT transferring unit 21c may transfer an NFT by the same procedure as for the transfer to the address of the user B described above. For example, if the NFT to be transferred is a non-fungible token according to the ERC-721 standard, the NFT transferring unit 21c may perform the process for transferring the NFT associated with the non-fungible asset to an address (e.g., an address of a wallet according to the ERC-721 standard) on an external blockchain network generated in accordance with the ERC-721 standard.

The NFT trading unit 21d performs trading of non-fungible assets tokenized as NFTs between users. In response to a user's operation of a user device, the NFT trading unit 21d may display the trading screen shown in FIG. 14 on the user device. FIG. 14 shows an example of the trading screen displayed on the user device. The trading screen includes a list of non-fungible assets exhibited by users. The trading screen shown in FIG. 14 includes the non-fungible assets 61, 64, 66. Although not shown, the trading screen may include NFT marks near the icons of the non-fungible assets 61, 64, 66. In some embodiments, if the trading screen allows trading of fungible assets in addition to non-fungible assets, NFT marks may distinguish the non-fungible assets from the fungible assets. Each of the non-fungible assets 61, 64, 66 has been exhibited (e.g., exhibited for sale) by a user owning the non-fungible asset. Utility tokens can be used to trade the non-fungible assets 61, 64, 66. For each of the non-fungible assets 61, 64, 66, the price for acquiring the asset is shown as the quantity of utility tokens. For example, a price of 3.49 RLT is shown in association with the non-fungible asset 61. The unit of utility tokens used in the video transmission system 1 may be“RLT.” The unit of utility tokens used in the video transmission system 1 may instead be another unit. In the illustrative example of FIG. 14, a user can acquire the non-fungible asset 61 in exchange for a payment of 3.49 RLT. Although the example in FIG. 14 shows a user-specified price associated with each non-fungible asset, these non-fungible assets may be sold in an auction form. In some embodiments, the NFT trading unit 21d may provide marketplace functionality. The marketplace functionality provided by the NFT trading unit 21d may be referred to as an “internal marketplace” for the server 20 or the services provided by the server 20. In order to acquire non-fungible assets on the trading screen (in the internal marketplace), the user access to a wallet may be required. The user may trade non-fungible assets using a wallet hosted by the server 20 in association with his/her user identification information in the services provided by the server 20. For example, the user A can use the wallet W10a hosted by the server 20 to trade non-fungible assets. The user may also use a wallet provided on his/her user device to trade non-fungible assets. For example, the user B may use the user device 10b to trade non-fungible assets.

The rewarding unit 21e can grant points to a user who is logged in to the video transmission service in response to actions of the user. The rewarding unit 21e may grant points to a user when, for example, any of the above-described activity information related to the user exceeds a predetermined threshold value. By way of an example, points can be granted when the viewing time exceeds one hour. By way of another example, points can be granted as a login bonus each time the user logs in. The rewarding unit 21e can store the points granted to a user on the storage (e.g., the storage 25) as a portion of the user management data 25c in association with the user ID of the user. The points may exchange for legal tender. The points may exchange for items that can be used in the virtual space.

If the user uses a wallet that can be used as an address on the blockchain network 30, the rewarding unit 21e can grant the user the utility tokens issued by executing the smart contract 33 instead of or in addition to the points, in response to the actions of the user. The conditions for granting the utility tokens may be the same as or different from the conditions for granting the points.

If the user uses a wallet that can be used as an address on the blockchain network 30, the user can convert his/her points to utility tokens. For example, the rewarding unit 21e may notify the user of the exchange rate between points and utility tokens. When the server receives an exchange request transmitted from the user device of the user, the rewarding unit 21e may cause the smart contract 33 to be executed based on the number of points designated in the exchange request and the exchange rate to issue the utility tokens to the user.

The user, who have acquired utility tokens, may exchange his/her utility tokens on the DEX (decentralized exchange) for other ERC-20 tokens. The DEX can, for example, execute smart contracts on the blockchain 31 for trading between ERC-20 tokens in an order book or automated market maker form. In the order book form, buying and selling orders may be placed off-chain and settlement may be made on-chain. In some embodiments, the DEX may not exchange utility tokens for legal tender. If the utility tokens are listed on the exchange 50 or any other exchange, the utility token may be exchanged for legal tender.

The wallet generating unit 21f generates a wallet in association with the user identification information of the user. A wallet generated by the wallet generating unit 21f is hosted by the server 20 and used by the user for trading of NFTs, management of utility tokens, and other processes. The wallet generating unit 21f can generate, for example, an ERC-721 compatible wallet. In some aspects, the wallet generating unit 21f may generate a wallet for a user when the user creates an account for a service provided by the server 20 (i.e., when the user starts using the service provided by the server 20). In some aspects, the wallet generating unit 21f may generate a wallet for a user who needs a wallet (e.g., who does not have an identified wallet) after starting to use a service of the server 20. For example, the wallet generating unit 21f can generate a wallet for a user when the user makes a request for a process that requires a wallet through the user device Examples of the request for a process requiring a wallet made by a user through the user device includes (1) a request for purchasing and/or acquiring an NFT or a non-fungible asset in the service provided by the server 20, (2) a request for tokenizing a non-fungible asset as an NFT, and (3) a request for acquiring an (on-chain) utility token. Requests for a process requiring a wallet made by the user through the user device are not limited to those listed above. In some aspects, the wallet generating unit 21f can generate a wallet for a user when the user needs a wallet in response to a request from another user or a process in the server 20. For example, if one user who currently does not use a wallet is given an NFT or a non-fungible asset from another user, the wallet generating unit 21f can generate a wallet for the one user. In another example, when granting an on-chain utility token to one user who currently does not use a wallet, the wallet generating unit 21f can generate a wallet for the one user.

In some embodiments, the wallet generating unit 21f may display a graphical user interface (GUI) for generating a wallet on the user device of a user when the user who started to use a service of the server 20 needs a wallet in the service. The GUI for generating a wallet is referred to herein as the “wallet generating UI.” For example, the wallet generating UI displays the terms of use for the wallet and, when the user agrees to the terms of use by operating an operation button included in the GUI, the wallet generating UI displays a screen for setting a password. When a password is set by the user, a key pair is created for the user, and a wallet using this key pair is generated for the user. Once the wallet has been generated for the user, the user can use the generated wallet to trade NFTs and acquire utility tokens.

The wallet generating UI may be displayed on a user device when a user who currently does not use a wallet operates the user device to transmit a request for tokenization as an NFT to the server.

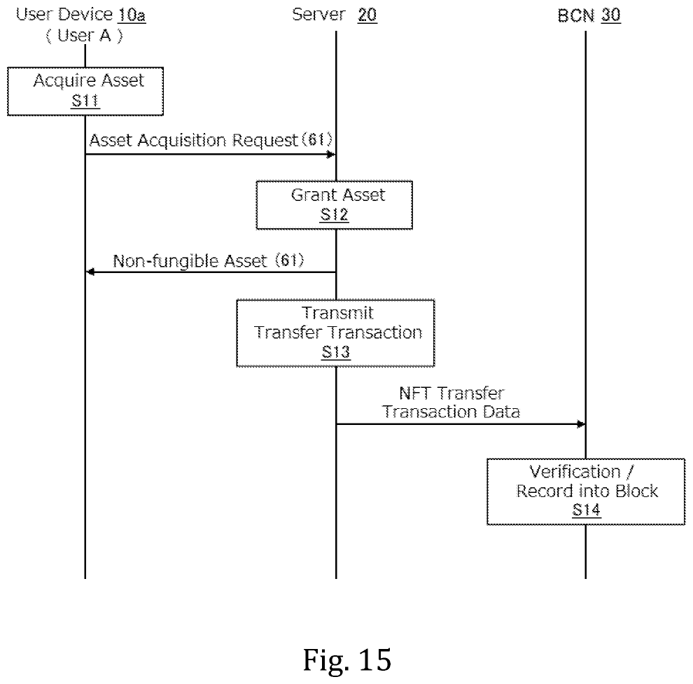

The following describes the process flow for the user A to acquire a non-fungible asset with reference to FIG. 15. Although the user device 10a used by the user A does not have a user wallet connected to the blockchain network 30, it is assumed that the user A uses the wallet W10a hosted by the server 20.

First, in step S11, the user device 10a transmits to the server 20 an asset acquisition request for acquiring the non-fungible asset 61. For example, when the purchase button associated with the non-fungible asset 61 is selected on the item purchase screen shown in FIG. 7, an asset acquisition request for acquiring the non-fungible asset 61 is transmitted from the user device 10a to the server 20. The price for purchasing the non-fungible asset 61 may be paid in legal tender, points granted to the user, utility tokens, crypto assets, etc. If the price for purchasing the non-fungible asset 61 is paid in utility tokens, the user A consumes a quantity of utility tokens corresponding to the price of the non-fungible asset 61. Thus, the balance of utility tokens for the user A managed in the wallet W10a is reduced by the quantity corresponding to the price of the non-fungible asset 61.

When the asset acquisition request is received, step S12 is performed, in which the user management data 25c is referred to to identify the wallet associated with the user identification information of the user A. The server 20, which hosts the wallet associated with the user identification information of the user A, can identify the wallet W10a of the user A. The server 20 grants the user A the non-fungible asset 61 designated in the asset acquisition request. The server 20 may add the asset ID of the non-fungible asset 61 to the owned asset information associated with the user ID of the user A in the user management data 25c.

After or in parallel with step S12, step S13 is performed, in which a process is started to transfer the non-fungible token associated with the non-fungible asset 61 to the user A. For example, in step S13, the server 20 generates the NFT transfer transaction data for transferring the non-fungible token associated with the non-fungible asset 61 from the operator address of the virtual space operator to the address of the wallet W10a of the user A, and transmits the generated NFT transfer transaction data to the blockchain network 30. The NFT transfer transaction data is transmitted to the blockchain network 30 along with the digital signature data generated by encrypting the NFT transfer transaction data with the private key of the wallet W10a.

Next, in step S14, the authenticity of the digital signature data is verified in the blockchain network 30. Once the authenticity of the digital signature data is confirmed, the blockchain network 30 records the NFT transfer transaction data associated with the digital signature data into the latest block of the blockchain 31. Thus, the blockchain 31 records the fact that the non-fungible token associated with the non-fungible asset 61 has been transferred from the virtual space operator to the user A.

The NFT transfer transaction data may specify the fee (referred to as the gas fee) for the blockchain network 30 to perform the verification. The gas fee can be paid in utility tokens, for example. The gas fee may be borne by the virtual space operator or by the user A. If the user A bears the gas fee, the quantity of utility tokens corresponding to the gas fee is subtracted from the balance of utility tokens for the user A, in response to the verification performed in step S14.

The user A can use the non-fungible asset 61 acquired from the server 20 in the virtual space provided by the server 20. For example, the user A can have his/her avatar 70a wear the non-fungible asset 61 acquired. When the non-fungible asset 61 is used in the virtual space, an indication element indicating that the non-fungible asset 61 has been tokenized as an NFT may be displayed in association with the non-fungible asset 61. For example, on the dress-up screen, the NFT mark 61a may be displayed near the icon of the non-fungible asset 61. After the avatar wears the non-fungible asset 61, the NFT mark or other indication elements that indicate that the non-fungible asset 61 has been tokenized as an NFT may still be displayed in association with the non-fungible asset 61, in order to indicate that the non-fungible asset 61 has been tokenized as an NFT.

Since the user A has also acquired the non-fungible token associated with the non-fungible asset 61, he/she can exhibit the non-fungible asset 61 in the marketplace. The non-fungible asset 61 exhibited in the marketplace is displayed on the trading screen, as shown in FIG. 14. Thus, the user A can put the non-fungible asset 61 into the secondary market through the marketplace.

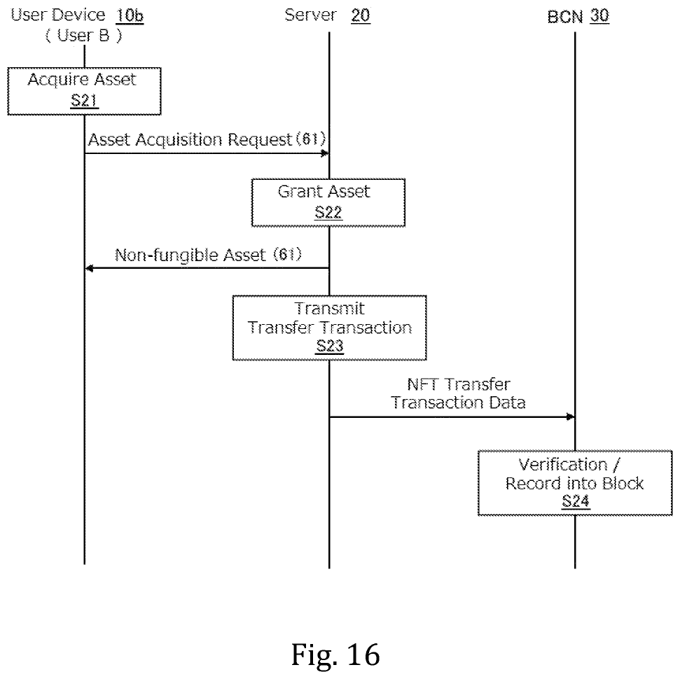

The following describes the process flow for the user B to acquire a non-fungible asset with reference to FIG. 16. The user device 10b used by the user B is assumed to have the user wallet W10b connected to the blockchain network 30, as shown in FIG. 1.

First, in step S21, the user device 10b transmits to the server 20 an asset acquisition request for acquiring the non-fungible asset 61. For example, when the purchase button associated with the non-fungible asset 61 is selected on the item purchase screen shown in FIG. 7, an asset acquisition request for acquiring the non-fungible asset 61 is transmitted from the user device 10b to the server 20. The non-fungible asset 61 may be purchased with the utility tokens. If the non-fungible asset 61 is purchased by the user B, the user B consumes a quantity of utility tokens corresponding to the price of the non-fungible asset 61. Thus, the balance of utility tokens for the user B is reduced by the quantity corresponding to the price of the non-fungible asset 61.

When the asset acquisition request is received, step S22 is performed, in which the server 20 grants the user B the non-fungible asset 61 designated in the asset acquisition request. The server 20 may add the asset ID of the non-fungible asset 61 to the owned asset information associated with the user ID of the user B in the user management data 25c. In step S22, the user management data 25c may be referred to to identify the wallet associated with the user identification information of the user B. If the user management data 25c stores the identification information of the user wallet W10b (e.g., the public key of the user wallet W10b), the server 20 can identify the user wallet W10b of the user B. In another embodiment, the asset acquisition request transmitted from the user device 10b may include the identification information of the user wallet W10b (e.g., the public key of the user wallet W10b). The user device 10b may transmit the identification of the user wallet W10b (e.g., the public key of the user wallet W10b) in association with the asset acquisition request. In these cases, the server 20 can identify the wallet used by the user B based on the identification information of the user wallet W10b received from the user device 10b.

After or in parallel with step S22, step S23 is performed, in which a process is started to transfer the non-fungible token associated with the non-fungible asset 61 to the user B. For example, in step S23, the server 20 generates the NFT transfer transaction data for transferring the non-fungible token associated with the non-fungible asset 61 from the operator address of the virtual space operator to the address of the user B, and transmits the generated NFT transfer transaction data to the blockchain network 30. The address of the user B on the blockchain network 30 is represented by the public key of the user wallet W10b. The NFT transfer transaction data is transmitted to the blockchain network 30 along with the digital signature data generated by encrypting the NFT transfer transaction data with the private key of the operator address.

Next, in step S24, the authenticity of the digital signature data is verified in the blockchain network 30. Once the authenticity of the digital signature data is confirmed, the blockchain network 30 records the NFT transfer transaction data associated with the digital signature data into the latest block of the blockchain 31. Thus, the blockchain 31 records the fact that the non-fungible token associated with the non-fungible asset 61 has been transferred from the virtual space operator to the user B.

The NFT transfer transaction data may specify the fee (referred to as the gas fee) for the blockchain network 30 to perform the verification. The gas fee can be paid in utility tokens, for example. The gas fee may be borne by the virtual space operator or by the user B. If the user B bears the gas fee, the quantity of utility tokens corresponding to the gas fee is subtracted from the balance of utility tokens for the user B, in response to the verification performed in step S24.

The user B can use the non-fungible asset 61 acquired from the server 20 in the virtual space provided by the server 20. When the non-fungible asset 61 is used in the virtual space, an indication element indicating that the non-fungible asset 61 has been tokenized as an NFT may be displayed in association with the non-fungible asset 61. For example, on the dress-up screen, the NFT mark may be displayed near the icon of the non-fungible asset 61. After the avatar wears the non-fungible asset 61, the NFT mark or other indication elements that indicate that the non-fungible asset 61 has been tokenized as an NFT may still be displayed in association with the non-fungible asset 61, in order to indicate that the non-fungible asset 61 has been tokenized as an NFT.

Since the user B also owns the non-fungible token associated with the non-fungible asset 61, he/she can exhibit the non-fungible asset 61 in the marketplace. The non-fungible asset 61 exhibited in the marketplace is displayed on the trading screen, as shown in FIG. 14. Thus, the user B can put the non-fungible asset 61 into the secondary market through the marketplace.

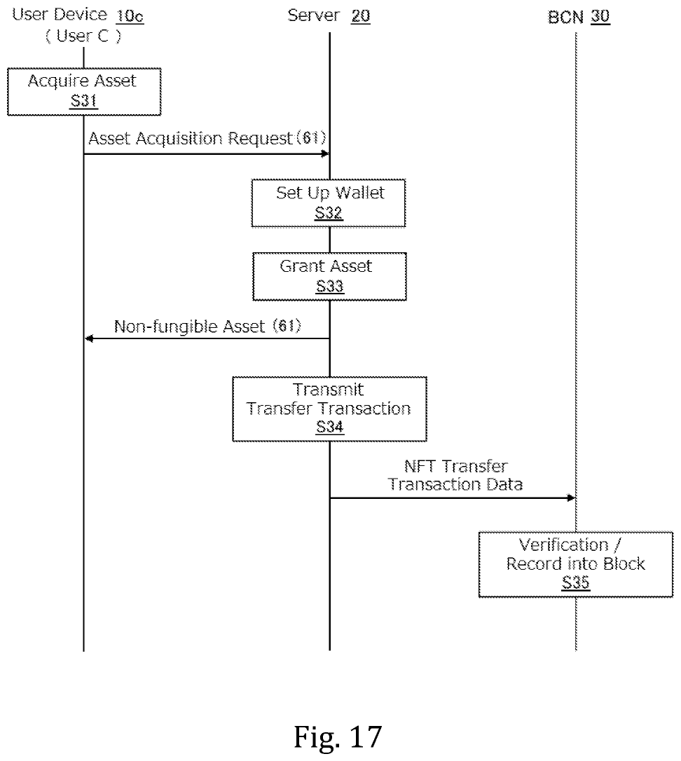

The following describes the process flow for the user C to acquire a non-fungible asset with reference to FIG. 17. It is assumed that the user device 10c used by the user C does not have a user wallet connected to the blockchain network 30, and the user C does not use a wallet hosted by the server 20.

First, in step S31, the user device 10c of the user C transmits to the server 20 an asset acquisition request for acquiring the non-fungible asset 61. For example, when the purchase button associated with the non-fungible asset 61 is selected on the item purchase screen shown in FIG. 7, an asset acquisition request for acquiring the non-fungible asset 61 is transmitted from the user device 10c to the server 20. The price for purchasing the non-fungible asset 61 may be paid in legal tender or points granted to the user.

When the asset acquisition request is received, step S32 is performed, in which the user management data 25c is referred to to identify the wallet associated with the user identification information of the user C. Since the server 20 does not host a wallet associated with the user identification information of the user C, the server 20 determines that no wallet has been set up for the user C, and generates a wallet in association with the user identification information of the user C. In step S32, the server 20 may display a wallet generating UI on the user device 10c to generate a wallet. The wallet generating UI may be displayed on the user device 10c at any time after the asset acquisition request is transmitted in step S31 and before the NFT transfer transaction data is created in step S34 (described later). When the wallet for the user C is generated, a key pair (a pair of a public key and a private key) of the wallet set up for the user C in association with the user identification information of the user C is stored as a portion of the user management data 25c.

After the wallet for the user C is set up, step S33 is performed, in which the server 20 grants the user C the non-fungible asset 61 designated in the asset acquisition request. The server 20 may add the asset ID of the non-fungible asset 61 to the owned asset information associated with the user ID of the user C in the user management data 25c.

Once the wallet for the user C has been set up, the user C can use the wallet for processes other than acquisition of the non-fungible asset shown in FIG. 17. The user C can, for example, acquire and consume utility tokens, trade NFTs, and use other functions of the wallet.

As described with reference to FIG. 15, the user A also uses the wallet W10a hosted by the server 20 to acquire non-fungible assets. As with the wallet of the user C, the wallet W10a used by the user A may be generated when a process that requires a wallet is performed in a service provided by the server 20 or when the user A starts to use a service of the server 20.

After or in parallel with step S33, step S34 is performed, in which a process is started to transfer the non-fungible token associated with the non-fungible asset 61 to the user C. For example, in step S34, the server 20 generates the NFT transfer transaction data for transferring the non-fungible token associated with the non-fungible asset 61 from the operator address of the virtual space operator to the address of the wallet of the user C set up in step S32, and transmits the generated NFT transfer transaction data to the blockchain network 30. The NFT transfer transaction data is transmitted to the blockchain network 30 along with the digital signature data generated by encrypting the NFT transfer transaction data with the private key of the wallet W10a.

Next, in step S35, the authenticity of the digital signature data is verified in the blockchain network 30. Once the authenticity of the digital signature data is confirmed, the blockchain network 30 records the NFT transfer transaction data associated with the digital signature data into the latest block of the blockchain 31. Thus, the blockchain 31 records the fact that the non-fungible token associated with the non-fungible asset 61 has been transferred from the virtual space operator to the user C.

The user C can use the non-fungible asset 61 acquired from the server 20 in the virtual space provided by the server 20. Since the user C has also acquired the non-fungible token associated with the non-fungible asset 61, he/she can exhibit the non-fungible asset 61 in the marketplace.

FIGS. 15 to 17 describe the process flow for the users A to C to purchase the non-fungible asset 61 from the virtual space operator, but the non-fungible asset 61 may be granted free of charge to a user by the virtual space operator. For example, when the user A takes a predetermined action in the virtual space provided by the server 20, when any of the activity information of the user A exceeds a predetermined threshold, or when any other condition related to the user A is satisfied, the non-fungible asset 61 or other non-fungible assets may be granted to the user A free of charge. The non-fungible asset 61 or other non-fungible assets may be granted free of charge (gifted) from another user to the user A. As is granted to the user A free of charge, the non-fungible asset may be granted to the user B or other users free of charge. If the user A acquires the non-fungible asset 61 by a method other than purchase for value, then the process of step S13 is performed after the non-fungible asset 61 is acquired or in parallel with the process of acquiring the non-fungible asset 61, and the non-fungible token associated with the non-fungible asset 61 acquired by the method other than purchase is transferred to the user A. If the user B acquires the non-fungible asset 61 by a method other than purchase for value, then the process of step S23 is performed after the non-fungible asset 61 is acquired or in parallel with the process of acquiring the non-fungible asset 61, and the non-fungible token associated with the non-fungible asset 61 acquired by the method other than purchase is transferred to the user B.

As described above, the user A who uses the wallet W10a hosted by the server 20 can acquire a non-fungible asset and receive the transfer of the non-fungible token associated with the non-fungible asset, in the same way as the user B who uses the user wallet W10b provided on the user device 10b. In addition, the user C, who is not using a wallet (e.g., wallet W10c) hosted by the server 20 at the time of sending an acquisition request for a non-fungible asset, can use the wallet generated by the server 20 to receive the transfer of the non-fungible asset. Therefore, the user A and the user C, who do not have a wallet on their respective user devices 10a, 10c, can use a wallet (e.g., the wallet W10a, a wallet created for user C by interaction with the GUI, etc.) hosted by the server 20 to acquire a non-fungible asset and own the non-fungible token associated with the non-fungible asset.

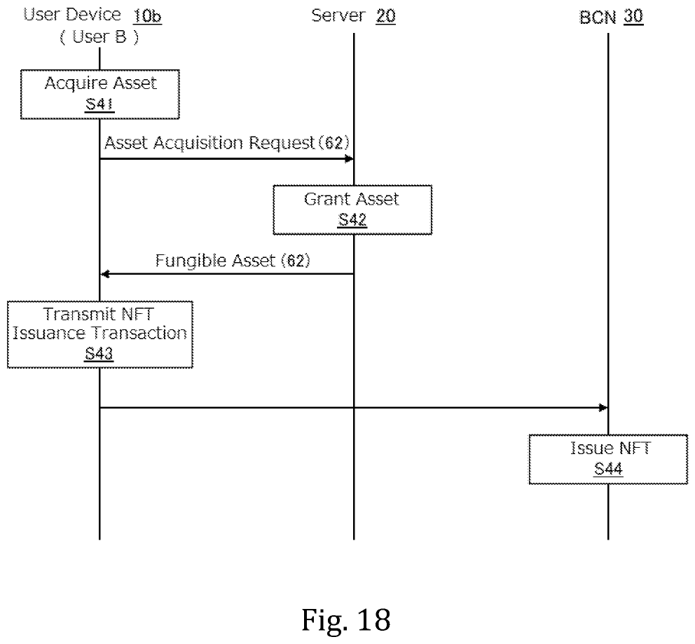

With reference to FIG. 18, the following describes the process flow for the user B to acquire a fungible asset and tokenize the acquired asset as an NFT (e.g., mint) using the user device 10b.

First, in step S41, the user device 10b transmits to the server 20 an asset acquisition request for acquiring the fungible asset 62. For example, when the purchase button associated with the fungible asset 62 is selected on the item purchase screen shown in FIG. 7, an asset acquisition request for acquiring the fungible asset 62 is transmitted from the user device 10b to the server 20.

When the asset acquisition request is received, step S42 is performed, in which the server 20 grants the user B the fungible asset 62 designated in the asset acquisition request. The server 20 may add the asset ID of the fungible asset 62 to the owned asset information associated with the user ID of the user B in the user management data 25c.

A user can acquire the fungible asset 62 in a variety of ways other than designating the fungible asset 62 for purchase for value. For example, a user may acquire a fungible asset selected randomly (or pseudo-randomly) through a gacha (or Loot Box) that can be used in the virtual space provided by the server 20. The price for purchasing the fungible asset 62 and/or the prince for using the gacha to acquire a fungible asset may be paid in legal tender, points granted to the user, utility tokens, crypto assets, etc.

If the user B wishes to tokenize as an NFT the fungible asset 62 that he/she has purchased or otherwise acquired, then the process for requesting the tokenization as an NFT is performed in step S43. Specifically, in step S43, NFT issuance transaction for issuing a non-fungible token is transmitted to the blockchain network 30 to tokenize the fungible asset 62 as an NFT. In step S44, the smart contract 32 is executed on the blockchain network 30 based on the NFT issuance transaction, and thus the non-fungible token associated with the fungible asset 62 is issued to the address of the user wallet W10b of the user B. When the non-fungible token associated with the fungible asset 62 is issued, the NFT issuance transaction data describing the transaction for issuing the non-fungible token is recorded in the latest block on the blockchain 31. In this way, the fungible asset 62 is converted to the non-fungible asset 64.

After the non-fungible token associated with the non-fungible asset 64 is issued to the address of the user wallet W10b, the user device 10b may notify the server 20 that the fungible asset 62 has been converted to the non-fungible asset 64. This notification may include the token ID of the non-fungible token associated with the non-fungible asset 64. Based on this notification, the server 20 can write the token ID included in the received notification into the token information associated with the asset ID of the fungible asset 62 in the asset management data 25b.

In order to execute the smart contract 32, the gas fee must be paid. The gas fee may be borne by the virtual space operator or by the user B. If the user B bears the gas fee, the quantity of utility tokens corresponding to the gas fee is subtracted from the balance of utility tokens for the user B, in response to the issuance of the non-fungible token.

As described above, the user B can convert the fungible asset 62 he/she acquired to the non-fungible asset 64. According to the same flow as in FIG. 18, a user can convert not only a fungible asset purchased from the virtual space operator, but also a fungible asset acquired by means other than purchase, to a non-fungible asset. Examples of fungible assets that can be converted to non-fungible assets include fungible assets acquired through a gacha, fungible assets gifted from another user, and fungible assets created by the user himself/herself.

After the NFT issuance transaction is transmitted to the blockchain network 30 in step S43, the user B can continue to use the fungible asset 62 in the virtual space. For example, the user B can continue to use the fungible asset 62 in the virtual space until an NFT is issued in the blockchain network 30, and the user B can use the non-fungible asset 64 generated by conversion from the fungible asset 62 in the virtual space after the NFT is issued. Since the non-fungible asset 64 is identical to the fungible asset 62 except that it has been tokenized as an NFT, the user B can use the non-fungible asset 64 tokenized as an NFT in the virtual space in the same manner as the fungible asset 62 before being tokenized as an NFT. For example, as shown in FIG. 7, if the fungible asset 62 is an object representing clothing that can be worn by an avatar, and the avatar of the user B wore the fungible asset 62 before the tokenization of the fungible asset 62 as an NFT, then the avatar of the user B can wear the non-fungible asset 64 generated by conversion from the fungible asset 62 even after the fungible asset 62 is tokenized as an NFT and converted to the non-fungible asset 64. Thus, the avatar of the user B can maintain consistency in its appearance before and after the tokenization as an NFT. However, an indication element such as the NFT mark indicating that the non-fungible asset 64 is a non-fungible asset (it has been tokenized as an NFT) may be displayed near the non-fungible asset 64 worn by the avatar of the user B. The appearance of the avatar of the user B may have a difference made by the indication element displayed to indicate that the asset has been tokenized as an NFT.

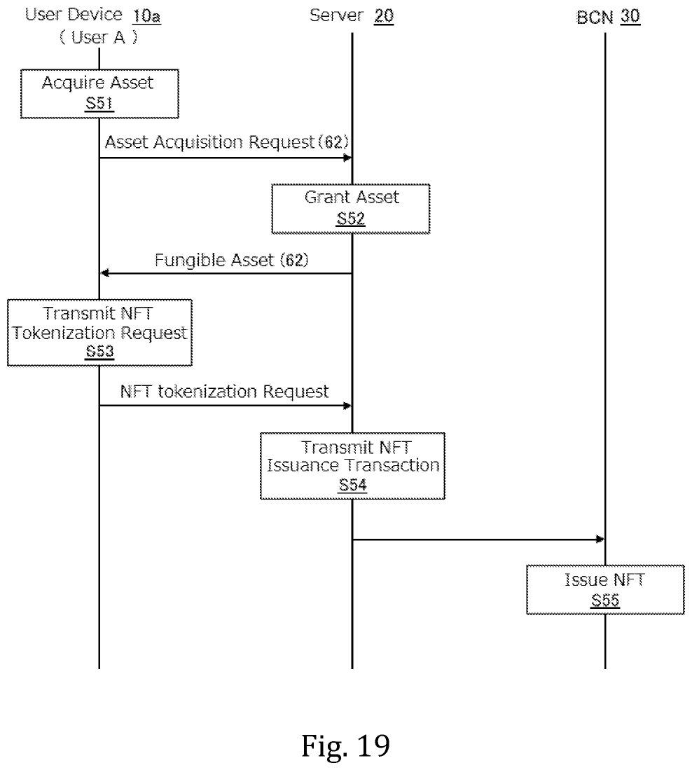

With reference to FIG. 19, the following describes the process flow for the user A to acquire a fungible asset and tokenize the acquired asset as an NFT (minting) using the user device 10a.

First, in step S51, the user device 10a transmits to the server 20 an asset acquisition request for acquiring the fungible asset 62. When the asset acquisition request is received, step S52 is performed, in which the server 20 grants the user A the fungible asset 62 designated in the asset acquisition request. The process in which the user A acquires the fungible asset 62 may be the same as the process in which the user B acquires the fungible asset 62.

If the user A wishes to tokenize as an NFT the fungible asset 62 that he/she has purchased or otherwise acquired, then step S53 is performed, in which the user A operates the user device 10a to transmit from the user device 10a to the server 20 an NFT tokenization request for requesting tokenization of the fungible asset 62 as an NFT.

When the NFT tokenization request is received by the server 20, step S54 is performed, in which the wallet W10a associated with the user identification information of the user A is identified. The wallet W10a associated with the user identification information of the user A is identified, for example, by referring to the user management data 25c. In order to tokenize the fungible asset 62 as an NFT, the server 20 generates NFT issuance transaction for issuing a non-fungible token to the address identified by the public key of the wallet W10a, and transmits the generated NFT issuance transaction to the blockchain network 30.

Next, in step S55, the smart contract 32 is executed on the blockchain network 30 based on the NFT issuance transaction, and thus the non-fungible token associated with the fungible asset 62 is issued to the address of the wallet W10a of the user A hosted by the server 20. When the non-fungible token associated with the fungible asset 62 is issued, the NFT issuance transaction data describing the transaction for issuing the non-fungible token is recorded in the latest block on the blockchain 31.

As described above, the fungible asset 62 is converted to the non-fungible asset 64 based on the NFT tokenization request transmitted from the user device 10a used by the user A to the server 20. Thus, in some embodiments, the user A who uses the user device 10a, which is not provided with a wallet, can also tokenize a fungible asset as an NFT by using the wallet hosted by the server 20.

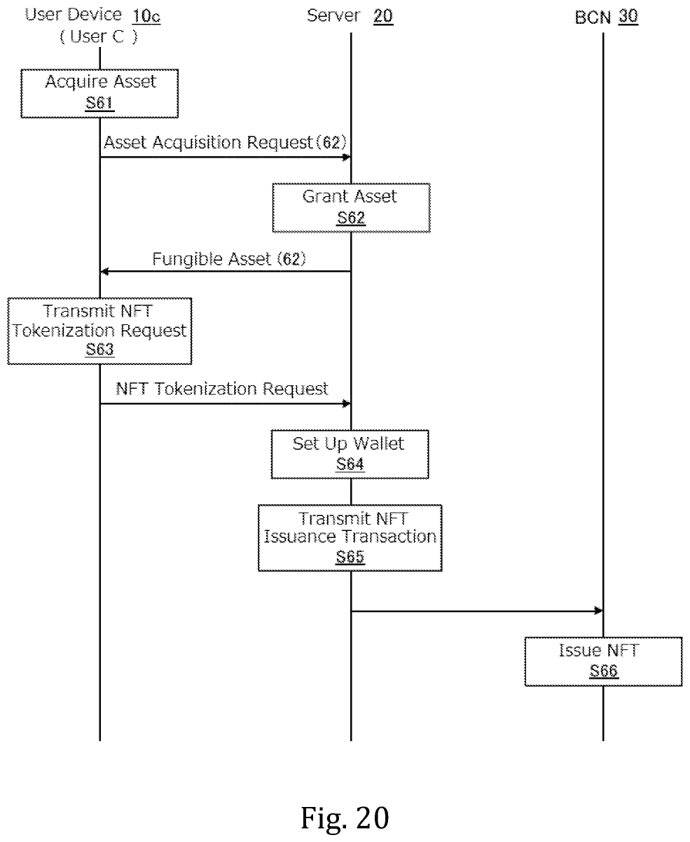

With reference to FIG. 20, the following describes the process flow for the user C to acquire a fungible asset and tokenize the acquired asset as an NFT (e.g., mint) using the user device 10c. The following description assumes that the server 20 does not host a wallet associated with the user identification information of the user C at the start of the process shown in FIG. 20.

First, in step S61, the user device 10c transmits to the server 20 an asset acquisition request for acquiring the fungible asset 62. When the asset acquisition request is received, step S62 is performed, in which the server 20 grants the user C the fungible asset 62 designated in the asset acquisition request. The process in which the user C acquires the fungible asset 62 may be the same as the process in which the user A and the user B acquire the fungible asset 62.

If the user C wishes to tokenize as an NFT the fungible asset 62 that he/she has purchased or otherwise acquired, then step S63 is performed, in which the user C operates the user device 10c to transmit from the user device 10c to the server 20 an NFT tokenization request for requesting tokenization of the fungible asset 62 as an NFT.

When the NFT tokenization request is received by the server 20, step S64 is performed, in which the user management data 25c is referred to to identify the wallet associated with the user identification information of the user C. Since the server 20 does not host a wallet associated with the user identification information of the user C, the server 20 determines that no wallet has been set up for the user C, and generates a wallet in association with the user identification information of the user C. In step S64, the server 20 may display a wallet generating UI on the user device 10c to generate a wallet. The wallet generating UI may be displayed on the user device at any time after the asset acquisition request is transmitted in step S61 and before the NFT issuance transaction data is created in step S65 (described later). When the wallet for the user C is generated, a key pair (a pair of a public key and a private key) of the wallet set up for the user C in association with the user identification information of the user C is stored as a portion of the user management data 25c.

Once the wallet for the user C is set up, in step S65, the server 20 generates an NFT issuance transaction for issuing a non-fungible token to the address identified by the public key of the wallet set up for the user C, and transmits the generated NFT issuance transaction to the blockchain network 30.

Next, in step S66, the smart contract 32 is executed on the blockchain network 30 based on the NFT issuance transaction, and thus the non-fungible token associated with the fungible asset 62 is issued to the address of the wallet of the user C hosted by the server 20. When the non-fungible token associated with the fungible asset 62 is issued, the NFT issuance transaction data describing the transaction for issuing the non-fungible token is recorded in the latest block on the blockchain 31.

Thus, in one embodiment, when an NFT tokenization request is made by the user C who is not using a wallet hosted by the server 20, a wallet for the user C is set up. The user C can use the wallet set up after making the NFT tokenization request to tokenize a fungible asset as an NFT.

As described above, each of the users using the service of the server 20 can tokenize as an NFT a fungible asset used in the service of the server 20 and convert it to a non-fungible asset, so as to own the NFT associated with the non-fungible asset. Fungible assets are digital data that can be reproduced, and thus fungible assets can be easily reproduced, making it difficult to recognize their asset value in the real world. According to the above embodiments, the user can tokenize as an NFT a fungible asset used in the service of the server 20 and is allowed to own the issued NFT (in other words, the address of the wallet used by the user is recorded as owner address information of the issued NFT), such that the user can be the one and only owner of the NFT. NFTs can be bought and sold using crypto assets in the marketplace, and crypto assets can be exchanged for legal tender. Therefore, when the user is recognized to be an owner of an NFT issued by tokenizing a fungible asset as an NFT, it is possible that the asset value in the real world derived from the fungible asset belongs to the user who tokenized the fungible asset as an NFT.

In the service provided by the server 20, many users presumably wish to acquire an NFT issued by tokenizing a rare fungible asset as an NFT. Therefore, the NFT issued by tokenizing as an NFT a fungible asset that is rare in the service provided by the server 20 is supposed to have a high asset value because of the relation of supply and demand. Examples of fungible assets that are rare in the service provided by the server 20 include: fungible assets provided from the virtual space operator to the users in a small number; fungible assets provided from the virtual space operator to the users in a limited quantity, fungible assets that were provided from the virtual space operator to the users in the past but not currently provided; fungible assets provided to the users for a limited time; fungible assets created by the users, and fungible assets owned by popular users. Popular users include users who are followed by more than a predetermined number of followers and users who have achieved a rank above a predetermined level.

The server 20 may have a function of sending a notification to a user owning a rare fungible asset to recommend that the fungible asset be tokenized as an NFT. For example, the server 20 may manage the number of instances granted to users for each fungible asset, identify fungible assets for which this number is smaller than a threshold as recommendation assets, and transmit an NFT recommendation notification to the user devices of the users who own the recommendation assets. The NFT recommendation notification may include an asset ID that identifies the recommendation asset. The user device that has received the NFT recommendation notification can identify the recommendation asset from among the fungible assets owned by the user based on the asset ID of the recommendation asset included in the NFT recommendation notification.

When transmitting the NFT recommendation notification to the user device of the user, the server 20 may refer to the user management data 25c to determine whether the user is using a wallet. If the user to whom the NFT recommendation notification is to be transmitted is not using a wallet hosted by the server 20, the server 20 may display the wallet generating UI described above on the user device of the user. This allows the user who has received the NFT recommendation notification to generate a wallet for the user before the NFT tokenization request is transmitted to the server 20. Thus, after making the NFT tokenization request for the fungible asset, the fungible asset can be tokenized as an NFT more smoothly (i.e., without being interrupted by the process for generating a wallet).

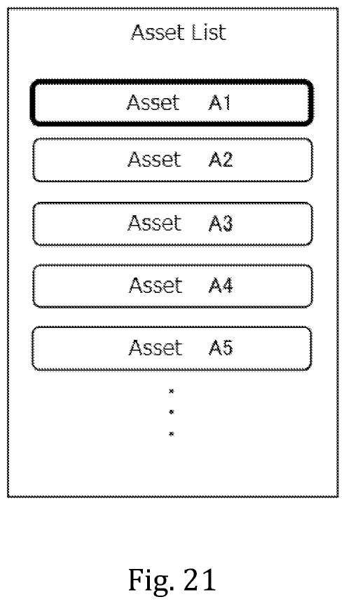

The user device (e.g., the user devices 10a, 10b, 10c) can display an asset list that shows in a list form the fungible assets owned by the user using the user device. In the asset list, the user device may display the recommendation assets in a different manner than other fungible assets. FIG. 21 shows an example of the asset list displayed on the user device. The example in FIG. 21 shows an asset list containing five fungible assets, the assets A1 to A5. If the asset A1 is a recommendation asset, the user device will highlight the icon for the asset A1 over the other icons, as shown.

The server 20 can calculate the market value of each fungible asset based on a predetermined algorithm and manage the calculated market value of each fungible asset in association with the asset ID of the fungible asset. Since fungible assets are assumed to be used within the virtual space provided by the server 20, the market value is calculated based on factors that affect the supply and demand of each fungible asset within the virtual space. The factors affecting the market value of a fungible asset may include one or more of the following: the number of the fungible assets provided from the virtual space operator to the users (e.g., supply count), the maximum number of the fungible assets that can be provided from the virtual space operator to the users (e.g., maximum supply count), whether the fungible asset is currently provided from the virtual space operator (e.g., availability), and the time elapsed since the fungible asset was provided to the users. The server 20 may maintain a wish list for each user of the virtual space to manage the digital assets (e.g., items) that the user wishes to acquire. The wish list may be stored on the storage 25 or other storage accessible to the server 20. The wish list may contain the asset IDs of the digital assets each user wishes to acquire, in association with the user ID of the user. The wish list may be updated at any time in response to user instructions. The server 20 may total the number of users on the wish list for each fungible asset and calculate the market value of each fungible asset such that the larger number of users results in a higher market value. The factors affecting the market value of fungible assets are not limited to those described above.

In some embodiments, the user device can display the fungible assets included in the asset list in the descending order of market value. For example, in the asset list shown in FIG. 21, the asset A1 having the highest market value may appear first (at the top), and fungible assets having a lower market value may appear at a lower position. In the asset list, the user device may display fungible assets having a market value higher than a predetermined threshold in a different manner than other fungible assets.

As described above, the user device can display rare fungible assets and fungible assets having a high market value in such positions as to be more likely to be selected by the user. This allows the user to easily find and select fungible assets that can be tokenized as an NFT expected to have a high value.

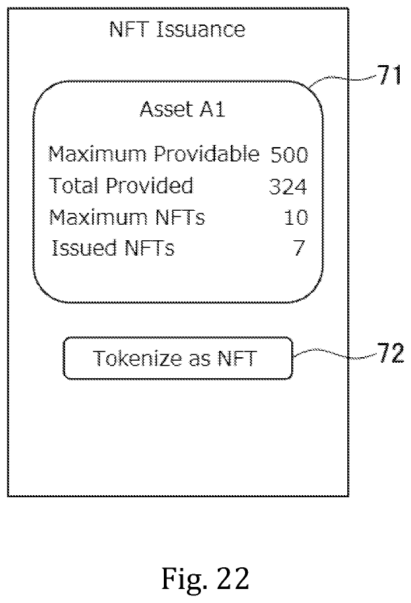

The user can select a fungible asset to be tokenized as an NFT from the asset list and then tokenize the selected fungible asset as an NFT. For example, when the asset A1 is selected by user operation in the asset list shown in FIG. 21, the user device displays an NFT issuance screen for tokenizing the asset A1 as an NFT. FIG. 22 shows an example of the NFT issuance screen displayed on the user device. As shown, the NFT issuance screen contains a window that displays information about the asset A1, and an NFT tokenization button 72 for tokenization as an NFT. The window 71 displays information about the asset A1 selected in the item list. In the example shown, the window 71 shows the maximum number (500) of the assets A1 that can be provided from the virtual space operator to users, the total number (324) of the assets A1 that have actually been provided to users, and maximum NFT issuance count (10) indicating the upper limit of the number of NFTs that can be issued by tokenizing the assets A1 as NFTs, and the NFT issuance count (7) indicating the number of NFTs that have actually been issued by tokenizing the assets A1 as NFTs. The NFT issuance screen may include information other than the above. Based on the information about the asset A1 displayed in window 71, the user can evaluate the rarity of the asset A1 and the asset value of the NFT issued by tokenizing the asset A1 as an NFT.

If the user wishes to tokenize the asset A1 as an NFT, the user selects the NFT tokenization button 72. When the NFT tokenization button 72 is selected on the user device, the asset A1 is tokenized as an NFT in a process flow depending on whether the user device has a wallet or not. If the user device has a wallet, an NFT issuance transaction for tokenizing the asset A1 as an NFT is transmitted to the blockchain network 30. In the blockchain network 30, the smart contract 32 is executed on the blockchain network 30 based on the NFT issuance transaction, and thus the non-fungible token associated with the asset A1 is issued to the address of the wallet of the user device (see step S44 in FIG. 18). If the user device does not have a wallet, the user device transmits to the server 20 an NFT tokenization request for the asset A1. If the server 20 hosts a wallet for the user of the user device, the server 20 generates the NFT issuance transaction and transmits the generated NFT issuance transaction to the blockchain network 30, as in step S54 in FIG. 19. If the server 20 does not host a wallet for the user of the user device, the server 20 sets up a wallet for the user by the same process as in step S64 in FIG. 20, and the server 20 generates the NFT issuance transaction by the same process as in step S65 and transmits the generated NFT issuance transaction to the blockchain network 30. In the blockchain network 30, the smart contract 32 is executed on the blockchain network 30 based on the NFT issuance transaction, and thus the non-fungible token associated with the asset A1 is issued to the address of the wallet hosted by the server 20.

The server 20 may set an upper limit on the number of issuable NFTs for each fungible asset. The upper limit on the number of issuable NFTs for each fungible asset is described in the smart contract 32, for example. The server 20 may set an upper limit on the supply count of fungible assets of the same type, thereby indirectly setting the upper limit on the number of NFTs issued by tokenizing the fungible assets as NFTs. In other words, if the upper limit of the supply count of a fungible asset supplied to users is set, the number of NFTs issued by tokenizing the fungible assets as NFTs will not exceed the upper limit of the supply count of the fungible asset.

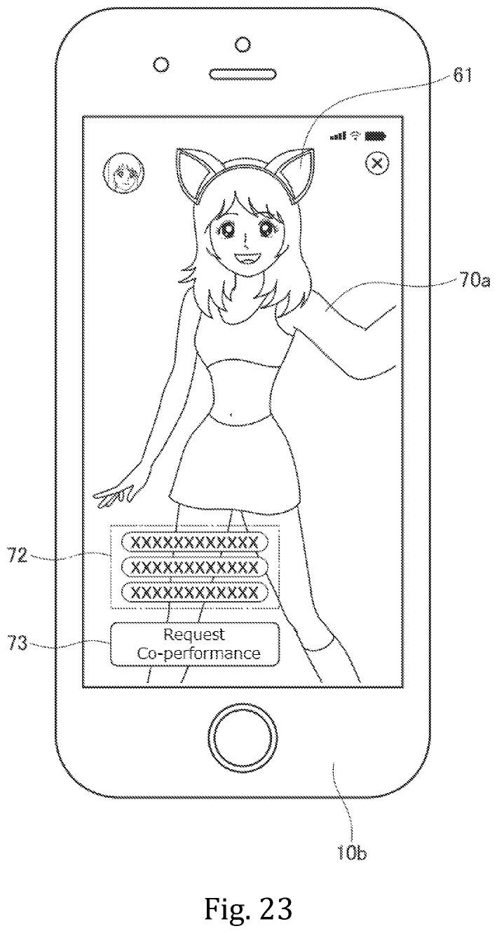

The following describes a co-performing function in the video transmission service. The co-performing function in the video transmission service refers to the function of allowing two or more users to co-perform via their respective avatars in a video. In the following description, it is assumed that, as shown in FIG. 23, the user B is viewing a video containing the avatar 70a of the user A on the user device 10b, and the user B requests co-performance with the user A while viewing the video.

As shown in FIG. 23, the user device 10b of the user B is playing the video containing the avatar 70a of the user A. The avatar 70a wears the non-fungible asset 61. In the video being played, the NFT mark 61a (not shown in FIG. 23) may be displayed close to or superimposed on the non-fungible asset 61 worn by the avatar 70a. The user device 10b displays comments 72 posted by viewers and a co-performance request button 73, both overlaid on the video being played. When the co-performance request button 73 is selected on the user device 10b, a co-performance request is transmitted from the user device 10b to the server 20.

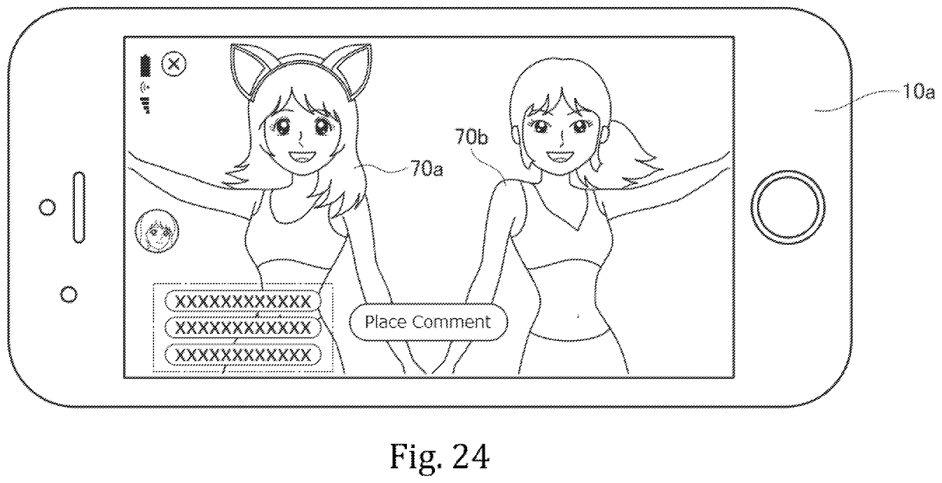

Upon receiving the co-performance request, the server 20 determines whether to permit the co-performance of the user B and the user A. When the co-performance of the user B and the user A is permitted, as shown in FIG. 24, the avatar 70b of the user B appears in the video being played, in addition to the avatar 70a of the user A. The server 20 transmits the video data of the video (co-performance video) containing the avatar 70a and the avatar 70b. In this way, the user A and the user B can perform together in the video via their respective avatars 70a and 70b.

When the co-performance request is made by the user B, the server 20 may permit the co-performance with the user A on the condition that the user B owns a particular non-fungible asset, and the server 20 may reject the co-performance request if the user B owns none of the particular non-fungible asset. Thus, the condition for permission of the co-performance is that the requester owns the particular non-fungible asset. The particular non-fungible asset that needs to be owned by a co-performance requesting user (in the above example, the user B) for permission of the co-performance requested by the co-performance requesting user may be herein referred to as a “non-fungible asset for co-performance.” In one embodiment, the non-fungible asset for co-performance that the user B needs to own is a native non-fungible asset (e.g., the non-fungible asset 61). In another embodiment, the non-fungible asset for co-performance is a converted non-fungible asset (e.g., the non-fungible asset 64). The non-fungible asset for co-performance may be at least one of the native non-fungible assets and the converted non-fungible asset. It is also possible that the requirement for permission of the co-performance of the user B is that the user B owns both a native non-fungible asset and a converted non-fungible asset.

In one embodiment, the non-fungible asset for co-performance may be a converted non-fungible asset that has been tokenized as an NFT by the user A. Thus, the co-performance requesting user is required to own a converted non-fungible asset tokenized as an NFT by the user A for permission of co-performance with the user A. Since it is the condition for permission of co-performance with the user A to own a converted non-fungible asset tokenized as an NFT by the user A, it is possible to increase the effect of the NFT associated with the converted non-fungible asset tokenized as an NFT by the user A and enhance the value of the NFT.

In another embodiment, the non-fungible asset for co-performance required for co-performance with the user A may be a converted non-fungible asset tokenized as an NFT by the user B or a converted non-fungible asset tokenized as an NFT by a user other than the user A and the user B.

In one embodiment, the non-fungible asset for co-performance may be a non-fungible asset that satisfies a predetermined condition. The non-fungible asset that satisfies a predetermined condition and thus can be used as a non-fungible asset for co-performance may be a native non-fungible asset issued during a particular time period or a converted non fungible asset tokenized as an NFT during a particular time period. The non-fungible asset that satisfies a predetermined condition and thus can be used as a non-fungible asset for co-performance may be a non-fungible asset of a particular type. The non-fungible asset of this particular type may be a co-performance ticket issued for co-performance or a co-performance ticket tokenized as an NFT for co-performance.

The non-fungible asset for co-performance used for co-performance with the user A may be a non-fungible asset tokenized as an NFT by the user A. In other words, it may be the condition for permission of co-performance of the user B with the user A that the user B owns a non-fungible asset tokenized as an NFT by the user A. The user A can generate a non-fungible asset for co-performance with himself/herself by tokenizing a fungible asset as an NFT. The user A may adjust the quantity of issued non-fungible assets for co-performance in accordance with his/her capacity to accept co-performance, his/her own branding strategy, and other factors. The non-fungible asset for co-performance tokenized as an NFT by the user A may have a period of validity during which it can be used as a non-fungible asset for co-performance.

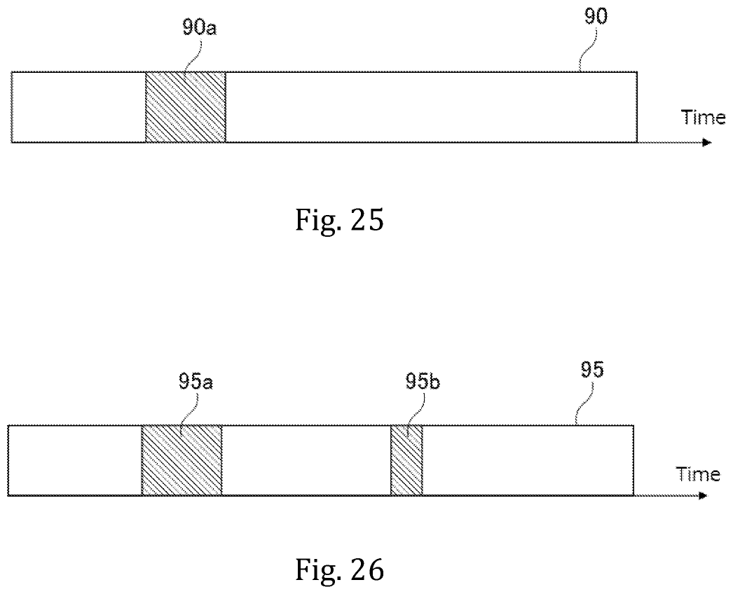

With reference to FIG. 25, the following describes the tokenization of the video data transmitted from the server 20 as an NFT. The video data transmitted from the server 20 may be archived for a predetermined period (e.g., one week from the end of distribution) on the storage 25 of the server 20. FIG. 25 shows the video data 90, which is the archived distributed video of the user A. The user A can designate a section of the archived video data 90 and tokenize the section as an NFT. For example, the user A may select a partial video 90a from the video data 90 and send to the server 20 an NFT tokenization request for tokenizing the partial video as an NFT. The partial video 90a may be stored on the storage 25 as a partial video file separate from the video data 90. The user A may tokenize the entirety of the archived video data 90 as an NFT.

The video data 90 may be archived data of a video taken by the user A in a live event held in a virtual live venue set up in the virtual space. The user A may tokenize as an NFT the video data 90 containing the video of a popular live event or the partial video 90a constituting a part of the video data 90 and sell for a profit the NFT associated with the video data 90 or the partial video 90a tokenized as an NFT.

The video data 90 may be archived data of a video taken from the point of view of the avatar of the user A while the avatar of the user A moves in the virtual space. Since the video taken from the point of view of the avatar of the user A reflects the personality of the user A, the user A can tokenize as an NFT the video data 90 corresponding to the video reflecting his/her personality or the partial video 90a constituting a part of the video data 90. The user A may sell for a profit the NFT associated with the video data 90 or the partial video 90a tokenized as an NFT.

The video data 90 may be archived data of a game play video of a game played by the user A.

Multiple virtual cameras may be set up in the virtual live venue. The virtual cameras set up in the live venue may include: a first virtual camera located at the front row of the stage of the live venue and facing the stage; a second virtual camera located on the stage of the live venue and facing the audience seats; and a third virtual camera that tracks one of the avatars performing or participating in the live show. The video data 90 may be a set of multiple video data captured by such multiple virtual cameras in the same time period. For example, the video data 90 may be a set of first video data representing the video captured by the first virtual camera, second video data representing the video captured by the second virtual camera, and third video data representing the video captured by the third virtual camera. The user A may select the partial video 90a from the first video data, the second video data, and the third video data and may tokenize the selected partial video 90a as an NFT. Thus, various video data can be tokenized as an NFT. In some embodiments, there is no limit on the number of virtual cameras set up in the virtual live venue. Four or more virtual cameras may be set up to capture the event held at the live venue. Events captured by multiple virtual cameras are not limited to the live event at the virtual live venue. It is also possible that a closed space set up in the virtual space is captured by multiple virtual cameras, and the videos each captured by one of the multiple virtual cameras are archived as multiple video data.

The user A may select multiple partial videos 90a from the first video data, the second video data, and the third video data, connect together the selected multiple partial videos to create an edited partial video, and tokenize the edited partial video as an NFT. A user with the ability to edit a video can tokenize the edited partial video as an NFT and sell for a profit the NFT associated with the edited partial video tokenized as an NFT.

The video represented by the video data 90 includes a view of the virtual space. The partial video 90a may include a view of the virtual space containing the avatar 70a of the user A. The video data 90 including a view of the virtual space may include a section in which the avatar 70a of the user A is present in the view and a section in which the avatar 70a of the user A is not present in the view. The user A can select the section of the video data 90 in which the avatar 70a is present in the view of the virtual space as the partial video 90a. The range in which the avatar 70a is present in the view of the virtual space included in the video data 90 may be extracted in accordance with a predetermined algorithm based on the video data 90 or related data stored in association with the video data 90. For example, the setting information of the virtual camera and the coordinate information representing the location of the avatar 70a may be stored for each timeline along with the video data 90. In this case, based on the setting information of the virtual camera and the coordinate information representing the location of avatar 70a in each timeline, it may be determined whether or not the avatar 70a is present in the view of the virtual space in each timeline. The user device 10a of the user A may display the range within the video data 90 in which the avatar 70a is present in the view of the virtual space in a different manner than other ranges, in order to assist the user A to select the partial video 90a.

The server 20 can perform the process of tokenizing as an NFT the partial video 90a designated in the NFT tokenization request, in the same manner as the server 20 does upon receiving the NFT tokenization request for a fungible asset. In order for the user A to make an NFT tokenization request, he/she needs to obtain a user wallet and connect the user wallet to the blockchain network 30 (obtain an address on the blockchain network 30).

In some embodiments, the server 20 may not delete the partial video 90a tokenized as an NFT from the storage even after the archive period has elapsed. The data in the video data 90 other than the partial video 90a tokenized as an NFT may be deleted after the archive period has elapsed. The server 20 may also store the partial video 90a in the file system 40 for backup purposes. In this way, the partial video 90a tokenized as an NFT may remain in the server 20 and/or the file system 40 such that it can be viewed upon a user request even after the archive period has elapsed.

The co-performance video in which the user A and the user B performed together may also be archived on the storage 25 of the server 20 for a predetermined period (e.g., one week from the end of distribution). FIG. 26 shows the video data 95 corresponding to the co-performance video. As with the selection of the partial video in the video data 90, the user A can designate a section of the archived video data and tokenize the section as an NFT. For example, the user A may select a partial video 95a from the video data 95 and send to the server 20 an NFT tokenization request for tokenizing the partial video 95a as an NFT.

Since the co-performance video contains not only the avatar 70a of the user A but also the avatar 70b of the user B, the user B can also designate a section of the video data 95 and tokenize the section as an NFT, such as a partial video 95b.

The smart contract 32 may define a rule for distribution of a profit that can be made by trading the NFT generated from the video data 95 of the co-performance video. For example, the smart contract 32 may define a rule of distributing the price between the user A and the user B at a predetermined proportion when the NFT generated from the video data 95 is sold. In some embodiments, in a co-performance video generated when the user B participates in the distributed video of the user A, the user A is designated as the host, and the user B is designated as a guest. When the NFT generated from the video data 95 of the co-performance video is traded, its price may be distributed such that a larger amount is paid to the user as the host than to the user as a guest, for example.

The tokenization of the partial video included in the video data of the co-performance video as an NFT may be enabled when permission is obtained from all the users who performed together in the co-performance video.

The following describes a partial description of advantageous effects achieved by the above embodiments.

In some above embodiments, the user A who uses the user device 10a not having a wallet can also use a non-fungible asset in the virtual space provided by the server 20 by using the wallet W10a generated in the server 20 in association with the user identification information of the user A. Therefore, the user A using the user device 10a not having a wallet and the user B using the user device 10b having the user wallet W10b can coexist in the virtual space provided by server 20 in which non-fungible assets are used. In other words, both the user A using the user device not having a wallet and the user B using the user device 10b having the user wallet W10b can participate in the virtual space provided by the server 20 via their respective avatars. Thus, according to some of the above embodiments, a user not using a wallet on his/her user device (e.g., the user A) can coexist with a user using a wallet on his/her user device, in the virtual space (or a platform thereof) provided by the server 20.

In some above embodiment, the user C not using a wallet can also coexist in the virtual space provided by the server 20, in addition to the user A using a wallet hosted by the server 20 and the user B using the wallet W10b provided on the user device 10b. For example, the user C can participate in the virtual space using his/her avatar and interact with the user A and the user B who are using their respective wallets in this virtual space. In addition, when the user C performs a process using a wallet, the server 20 generates a wallet in association with the user identification information of the user C, and thus the user C can also use non-fungible assets and NFTs. Thus, the user C can use the services provided by the server 20 without using a wallet and then start using a wallet as necessary.

The user A, who do not have a wallet on his/her user device 10a, can use a wallet hosted by the server 20 in association with his/her user identification information and thus connect to the blockchain network 30, such that the user A can exhibit a non-fungible asset in the marketplace for a profit.

According to some above embodiments, the functions using the blockchain network 30 can be provided not only to the user B using the user device 10b having the user wallet W10b, but also to the user A and the user C using the user devices 10c, respectively, not having a wallet, by using the wallets hosted by the server Thus, the above embodiments can contribute to expanding the user base for the blockchain network.

In some above embodiments, a user owning a fungible asset can tokenize the fungible asset as an NFT. When a user uses a fungible asset in the virtual space, the fungible asset may become an item that symbolizes the user. In the real world, when a celebrity wears the same clothing repeatedly, ready-made clothing that is inherently fungible may become an item that symbolizes the celebrity. Similarly in the virtual space, a fungible asset may become an item that symbolizes a certain user. In this case, this user would wish the fungible asset to be unique. According to the above embodiments, a fungible asset acquired from the server 20 is tokenized as a non-fungible token in response to a tokenization request from the user, making it possible to fulfill the user's request to tokenize the fungible asset as an NFT. NFTs are traded in the real world and have asset value. When a user is allowed to tokenize as an NFT a fungible asset provided from the server 20 or a fungible asset created by the user, the user is allowed to form assets in the real world through the use of the services provided by the server 20.

In some above embodiments, the first user and the second user can tokenize as NFTs different partial videos extracted from a video including the virtual space containing the first avatar of the first user and the second avatar of the second user. This allows partial videos to be extracted in accordance with each user's personality from a video in which multiple users are participating via their avatars, and the partial videos that represent the personality can be tokenized as non-fungible tokens.

The video transmission system 1 shown in FIG. 1 is an example of the system that can employ the present invention, and the system that can employ the present invention is not limited to that shown in FIG. 1. The video transmission system 1 that can employ the present invention may not include a part of the components shown. For example, if non-fungible tokens are implemented fully on-chain, the video transmission system 1 need not have the file system 40. The video transmission system 1 may include a component not shown. For example, although FIG. 1 shows only three user devices 10 for simplicity of explanation, the video transmission system 1 may include four or more user devices 10. The video transmission system 1 may have a cloud environment for distributed processing of the processes to be performed by the user devices 10 or the server 20.

In the video transmission system 1, the data may be stored in any appropriate location. For example, the various data that may be stored on the storage 25 may also be stored on a storage or a database server that is physically separate from the storage 25. The data described herein as being stored on the storage 25 may be stored on a single storage or stored decentrally on more than one storage. The simple phrase “storage” mentioned herein or recited in the claims may refer to a single storage or a collection of a plurality of storages as long as the context allows it.

Embodiments of the disclosure are not limited to the above embodiments, but various modifications are possible without departing from the scope of the invention. For example, some or all of the functions executed by the processor 21 may be realized by a processor which is not explicitly mentioned herein without departing from the scope of the invention. Although the processor 21 is illustrated as a single component in FIG. 5, the processor 21 may be a collection of a plurality of physically separate processors. In this specification, a program or instructions included in the program that are described as being executed by the processor 21 may be executed by a single processor or executed by a plurality of processors in a distributed manner. Further, a program or instructions included in the program executed by the processor 21 may be executed by one or more virtual processors.

Programs executed by the processor 21 can be stored on various types of non-transitory computer readable media, in addition to the storage shown in the drawing. The non-transitory computer readable media include various types of tangible storage media. Examples of the non-transitory computer readable media include magnetic recording media (e.g., flexible disks, magnetic tape, hard disk drives), magneto-optical recording media (e.g., magneto-optical disks), compact disc read only memory (CD-ROM), CD-R, CD-R/W, and semiconductor memory (e.g., mask ROM, programmable ROM (PROM), erasable PROM (EPROM), flash ROM, random access memory (RAM)).

As described above, the present invention is applicable not only to the video transmission system 1 but also to other systems. For example, the present invention can be applied to a game system in which a user device and a server cooperate to provide games. The game system to which the present invention is applied can employ the same architecture as shown in FIG. 1. More specifically, the game system to which the present invention is applied can be implemented by modifying the video transmission system shown in FIG. 1 as follows. The user devices 10a to 10c are configured to execute a set of instructions contained in a game application program to perform various game-related functions. The server 20 is configured to provide various game-related functions to user devices 10a to 10c. The user devices 10a to 10c and the server 20 can cooperate with each other to perform various functions of a game.

Embodiments of the present invention applied to a game system will be hereinafter described. In the following description, the term “game system” can mean a game system to which the present invention can be applied, and the term “game” can mean a game provided by the game system to which the present invention is applied. Various game contents may be used in games provided by the game system. The game contents are electronic data used in the games. The game contents can include, for example, characters, cards, items, points, in-service currency (or in-game currency), tickets, characters, avatars, parameters, and other electronic data used in the games. The game contents can be acquired, owned, used, managed, exchanged, integrated, reinforced, sold, abandoned, or donated in the games by users. The game contents may be used in other ways.

Various digital assets are used in the games. The game contents are an example of digital assets used in the games. The various objects that constitute the game space can also be a type of digital asset. The game space may be, for example, a three-dimensional virtual space in which the user's character can move. The digital assets used in the games can be classified into multiple categories, including fungible assets and non-fungible assets, as with the digital assets used in the virtual space of the video transmission service described above.

A game screen displayed on a user device when a game is played may be distributed to other user devices. A running commentary given by the user playing the game may be distributed to the user devices of other users along with the game screen.

The description of fungible assets and non-fungible assets used in the video transmission system 1 contained herein also applies to fungible assets and non-fungible assets used in the game system to which the present invention is applied. For example, in a game provided by the game system to which the present invention is applied, a user may be able to acquire an item that is a non-fungible asset and use the acquired non-fungible asset in the game. The user may also acquire an item that is a fungible asset and tokenize the item, or the fungible asset, as an NFT.

If the game includes a quest or mission that is intended to be completed by the user, the acquisition of a given non-fungible asset may be a condition for completing the quest or mission. Alternatively, owning a given non-fungible asset may be a condition for participating in a quest or mission included in the game.

When the present invention is applied to a game system for providing a game, the parcels of land constituting the game space (virtual space) of the game, the buildings in the game space, and other components in the game space may be tokenized as NFTs, and these components of the game space tokenized as NFTs may be granted or sold to the user.

As with the video transmission system 1, in the game provided by the game system to which the present invention is applied, coexistence is possible between users who use a wallet provided on the user device, users who use a wallet hosted by the server, and users who do not use a wallet. For example, the user A who uses the user device 10a not having a wallet can use a non-fungible asset in the game provided by the server 20 by using the wallet W10a generated in the server 20 in association with the user identification information of the user A. Therefore, the user A using the user device 10a not having a wallet and the user B using the user device 10b having the user wallet W10b can coexist in the game provided by the server 20 in which non-fungible assets are used. In addition, in the game provided by the game system to which the present invention is applied, coexistence is also possible for the user C who does not use a wallet. For example, the user C can play the game with the user A and the user B by using items and characters that are fungible assets. When the user C performs a process using a wallet, the server 20 generates a wallet in association with the user identification information of the user C, and thus the user C can also use non-fungible assets and NFTs. Thus, the user C can use the services provided by the server 20 without using a wallet and then start using a wallet as necessary.

The game system to which the present invention is applied can provide various types of games. Games provided by the game system to which the present invention is applied may include role-playing games, shooting games, battle games using card games, and other various types of games.

As described above, the games provided by the game system to which the present invention is applied may be provided to a user via a user device that stores the application programs of the games. In other words, the games provided by the game system to which the present invention is applied may be native games made playable by native applications. The application programs may be downloaded from a distribution platform for digital contents to the user device. The games provided by the game system to which the present invention is applied may be web games executed by a web browser rather than by dedicated applications for the games.

The games provided by the game system to which the present invention is applied may be games using the Move-to-Earn mechanism (hereinafter referred to as “Move-to-Earn games”). In Move-to-Earn games, a user can earn tokens, points, experience points, and/or other rewards that can be used in the games based on the distance the user traveled carrying or wearing his/her user device. In Move-to-Earn games, a user may be granted with items tokenized as NFTs in accordance with the distance traveled by the user.

The present invention is applicable not only to the video transmission system 1 and the game system, but also to various distributed application services using the blockchain technology (e.g., the blockchain network 30 described above). For example, the present invention can be applied to DeFi (decentralized finance) services and insurance services using the blockchain technology.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be stored distributively in a plurality of memories included in a single apparatus or in a plurality of memories arranged distributively in a plurality of apparatuses. The elements of the software and the hardware described herein can be integrated into fewer constituent elements or can be decomposed into more constituent elements.

The procedures described herein, particularly those described with a flowchart or a sequence diagram, are susceptible of omission of part of the steps constituting the procedure, adding steps not explicitly included in the steps constituting the procedure, and/or reordering the steps. The procedure subjected to such omission, addition, or reordering is also included in the scope of the invention unless departing from the true scope and spirit of the present invention.

The words “first,” “second,” and “third” used in this specification and the claims are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A video data transmission method for transmitting video data including a view of a virtual space in which a plurality of avatars are allowed to participate, the plurality of avatars each associated with one of a plurality of users including a first user, the method comprising the steps of:

generating a first wallet in association with first user identification information identifying the first user in the virtual space; and

granting, in response to a first acquisition request from the first user, the first user a first non-fungible asset among one or more non-fungible assets that are digital assets for use in the virtual space and tokenized as non-fungible tokens, and transferring a first non-fungible token associated with the first non-fungible asset to an address of the first wallet.

### Additional Embodiment 2

The video data transmission method according to Additional Embodiment 1, further comprising the steps of:

granting, in response to a second acquisition request from the first user, the first user a first fungible asset among one or more fungible assets that are digital assets for use in the virtual space and not tokenized as non-fungible tokens; and performing, in response to a tokenization request from the first user, a tokenization process for tokenizing the first fungible asset as a non-fungible token.

### Additional Embodiment 3

The video data transmission method according to Additional Embodiment 1 or 2, wherein the first wallet is generated when the first user needs the first wallet.

### Additional Embodiment 4

The video data transmission method according to Additional Embodiment 2, wherein the first wallet is generated when the first acquisition request is received, when the tokenization request is received, or when the first user identification information is created.

### Additional Embodiment 5

The video data transmission method according to any one of Additional Embodiments 1 to 4, further comprising the step of:

transmitting, by means of one or more processors, to a blockchain network, transfer transaction data for recording on a blockchain a transaction for transferring a owner of the first non-fungible token associated with the first non-fungible asset to the address of the first wallet.

### Additional Embodiment 6

The video data transmission method according to any one of Additional Embodiments 1 to 5, further comprising the step of:

performing a token issuance process for issuing a utility token usable in the virtual space.

### Additional Embodiment 7

The video data transmission method according to Additional Embodiment 6, wherein the utility token is exchangeable for a crypto asset other than the utility token.

### Additional Embodiment 8

The video data transmission method according to Additional Embodiment 6 or 7, wherein the utility token is granted to the first user based on an activity of the first user in the virtual space.

### Additional Embodiment 9

The video data transmission method according to Additional Embodiment 8, wherein in response to the first acquisition request, the utility token of the first user is consumed in a quantity corresponding to a price of the first non-fungible asset.

### Additional Embodiment 10

The video data transmission method according to any one of Additional Embodiments 1 to 9, further comprising the step of:

performing a token issuance process for issuing a utility token usable in the virtual space,

wherein a cost of performing the tokenization process is paid in the utility token of the first user.

### Additional Embodiment 11

The video data transmission method according to Additional Embodiment 5, further comprising the step of:

performing a token issuance process for issuing a utility token usable in the virtual space,

wherein a cost of recording the transfer transaction data on the blockchain network is paid in the utility token of the first user.

### Additional Embodiment 12

The video data transmission method according to any one of Additional Embodiments 1 to 11,

wherein a first avatar associated with the first user participates in the virtual space, and

wherein the video data transmission method further comprises the step of performing, by means of one or more processors, in response to a first video tokenization request from the first user, a process for tokenizing as a non-fungible token a first partial video that is a part of the video data and includes a view of the virtual space containing the first avatar.

### Additional Embodiment 13

The video data transmission method according to Additional Embodiment 12,

wherein a second avatar associated with a second user further participates in the virtual space, and

wherein the video data transmission method further comprises the step of performing, in response to a second video tokenization request from the second user, a process for tokenizing as a non-fungible token a second partial video that is a part of the video data and includes a view of the virtual space containing the second avatar.

### Additional Embodiment 14

The video data transmission method according to any one of Additional Embodiments 1 to 11, further comprising the step of:

in response to receiving from a second user a co-performance request for co-performance of a second avatar associated with the second user and a first avatar associated with the first user, transmitting video data of a co-performance video including the first avatar and the second avatar if the second user owns at least one of the one or more non-fungible assets, and rejecting the co-performance request for co-performance with the first avatar if the second user owns none of the one or more non-fungible assets.

### Additional Embodiment 15

The video data transmission method according to any one of Additional Embodiments 1 to 14, further comprising the step of:

in response to receiving from a second user a co-performance request for co-performance of a second avatar associated with the second user and a first avatar associated with the first user, transmitting video data of a co-performance video including the first avatar and the second avatar if the second user owns a converted non-fungible asset generated by tokenizing at least one of the one or more fungible assets as a non-fungible token, and rejecting the co-performance request for co-performance with the first avatar if the second user does not own the converted non-fungible asset.

### Additional Embodiment 16

The video data transmission method according to any one of Additional Embodiments 1 to 15,

wherein the virtual space includes a closed space, and

wherein the video data transmission method further comprises the step of permitting a first avatar associated with the first user to enter the closed space if the first user owns at least one of the one or more non-fungible assets, and prohibiting the first avatar from entering the closed space if the first user owns none of the one or more non-fungible assets.

### Additional Embodiment 17

The video data transmission method according to any one of Additional Embodiments 1 to 16,

wherein the virtual space includes a closed space, and

wherein the video data transmission method further comprises the step of permitting a first avatar associated with the first user to enter the closed space if the first user owns a converted non-fungible asset generated by tokenizing at least one of the one or more fungible assets as a non-fungible token, and prohibiting the first avatar from entering the closed space if the first user does not own the converted non-fungible asset.

### Additional Embodiment 18

The video data transmission method according to any one of Additional Embodiments 1 to 17,

wherein the first user owns a plurality of wearable assets that can be worn by a first avatar of the first user in the virtual space, the plurality of wearable assets being included in the one or more fungible assets, and

wherein the video data transmission method further comprises the step of performing, by means of one or more processors, in response to a tokenization request from the first user, a process for tokenizing a set of the plurality of wearable assets as a non-fungible token.

### Additional Embodiment 19

A video data transmission system including one or more processors and configured to transmit video data including a view of a virtual space in which a plurality of avatars are allowed to participate, the plurality of avatars each associated with one of a plurality of users including a first user,

wherein the one or more processors execute computer-readable instructions to:

generate a first wallet in association with first user identification information identifying the first user in the virtual space; and

grant, in response to a first acquisition request from the first user, the first user a first non-fungible asset among one or more non-fungible assets that are digital assets for use in the virtual space and tokenized as non-fungible tokens, and transfer a first non-fungible token associated with the first non-fungible asset to an address of the first wallet.

### Additional Embodiment 20

A video data transmission program for causing one or more processors to transmit video data including a view of a virtual space in which a plurality of avatars are allowed to participate, the plurality of avatars each associated with one of a plurality of users including a first user,

wherein the program causes the one or more processors to:

generate a first wallet in association with first user identification information identifying the first user in the virtual space; and

grant, in response to a first acquisition request from the first user, the first user a first non-fungible asset among one or more non-fungible assets that are digital assets for use in the virtual space and tokenized as non-fungible tokens, and transfer a first non-fungible token associated with the first non-fungible asset to an address of the first wallet.

### LIST OF REFERENCE NUMBERS

1 video transmission system
10a, 10b user device
20 server
21a video transmitting unit
21b NFT requesting unit
21c NFT transferring unit
21d NFT trading unit
21e rewarding unit
21f wallet generating unit
30 blockchain network
31 blockchain
40 file system
50 exchange
70b avatar
W10a wallet
W10b user wallet

1. A video data transmission method for transmitting video data including a view of a virtual space in which a plurality of avatars are allowed to participate, the plurality of avatars each associated with one of a plurality of users including a first user, by executing computer readable instructions by one or more processors, wherein the one or more processors are either provided with or in communication with one or more servers that store user identification information for a plurality of users of the virtual space, a first server of the one or more servers storing one or more server-hosted wallets, the method comprising the steps of:
preparing data for generating a view of a virtual space in which at least a first avatar participates, the first avatar associated with a first user;
transmitting the data for generating the view of the virtual space to a display of a user device of the first user;
in response to an asset acquisition request from the user device of the first user in the virtual space,
determining if the user identification information for the first user is associated with any one of the server-hosted wallets;
based on a determination that the user identification information for the first user is not associated with any one of the server-hosted wallets,
generating a first wallet in association with first user identification information for the first user; and
storing the first wallet as a server-hosted wallet on the first server in association with the user identification information for the first user;
transferring, in response to storage of the first wallet on the first server, a first non-fungible asset among one or more non-fungible assets that are digital assets for use in the virtual space and tokenized as non-fungible tokens, the first non-fungible asset corresponding to the asset acquisition request, to an address of the first wallet; and
causing the display of the user device of the first user to depict a representation of the first non-fungible asset for selection by the first user.

2. The video data transmission method according to claim 1, wherein transferring the first non-fungible asset further comprising the steps of:
in response to the asset acquisition request from the first user in the virtual space, determining if the asset acquisition request corresponds to a first fungible asset;
based on a determination that the asset acquisition request corresponds to the first fungible asset, granting the first fungible asset among one or more fungible assets that are digital assets for use in the virtual space and not tokenized as non-fungible tokens to the first user;
performing, in response to a tokenization request from the first user corresponding to the first fungible asset, a tokenization process for tokenizing the first fungible asset as a first non-fungible token; and
storing the first non-fungible token in the first wallet on the server in association with the first user identification information.

3. The video data transmission method according to claim 1, wherein generating the first wallet further comprises generating the first wallet in response to receipt of a request for a wallet from the first user.

4. The video data transmission method according to claim 2, wherein the first wallet is generated when the asset acquisition request is received, when the tokenization request is received, or when the first user identification information is received.

5. The video data transmission method according to claim 1, further comprising the step of:
transmitting, by means of one or more processors, to a blockchain network, transfer transaction data for recording on the blockchain network a transaction transferring ownership of a first non-fungible token associated with the first non-fungible asset to the address of the first wallet.

6. The video data transmission method according to claim 1, further comprising the step of: performing a token issuance process for issuing a utility token usable in the virtual space.

7. The video data transmission method according to claim 6, wherein the utility token is exchangeable for a crypto asset other than the utility token.

8. The video data transmission method according to claim 6, wherein the utility token is granted to the first user based on an activity of the first user in the virtual space.

9. The video data transmission method according to claim 7, wherein in response to the asset acquisition request, the utility token of the first user is consumed in a quantity corresponding to a price of the first non-fungible asset.

10. The video data transmission method according to claim 2, further comprising the step of:
performing a token issuance process for issuing a utility token to the first user usable in the virtual space,
wherein a cost of performing the tokenization process is deducted from the utility token of the first user.

11. The video data transmission method according to claim 5, further comprising the step of:
performing a token issuance process for issuing a utility token to the first user usable in the virtual space,
wherein a cost of recording the transfer transaction data on the blockchain network is deducted from the utility token of the first user.

12. The video data transmission method according to claim 1,
wherein a first avatar associated with the first user participates in the virtual space, and
wherein the video data transmission method further comprises the step of performing, by means of the one or more processors, in response to a first video tokenization request from the first user, a process for tokenizing as a non-fungible token a first partial video that is a part of the video data and includes a view of the virtual space containing the first avatar.

13. The video data transmission method according to claim 12,
wherein a second avatar associated with a second user further participates in the virtual space, and
wherein the video data transmission method further comprises the step of performing, in response to a second video tokenization request from the second user, a process for tokenizing as a non-fungible token a second partial video that is a part of the video data and includes a view of the virtual space containing the second avatar.

14. The video data transmission method according to claim 1, further comprising the step of:
in response to receiving from a second user a co-performance request for co-performance of a second avatar associated with the second user and a first avatar associated with the first user, determining if the second user owns at least one of the one or more non-fungible assets; and
transmitting video data of a co-performance video including the first avatar and the second avatar based on the determination that the second user owns one or more of the one or more non-fungible assets.

15. The video data transmission method according to claim 2, further comprising the step of:
in response to receiving from a second user a co-performance request for co-performance of a second avatar associated with the second user and a first avatar associated with the first user, transmitting video data of a co-performance video including the first avatar and the second avatar if the second user owns a converted non-fungible asset generated by tokenizing at least one of the one or more fungible assets as a non-fungible token, and rejecting the co-performance request for co-performance with the first avatar if the second user does not own the converted non-fungible asset.

16. The video data transmission method according to claim 1,
wherein the virtual space includes a closed space, and
wherein the video data transmission method further comprises the step of permitting a first avatar associated with the first user to enter the closed space if the first user owns at least one of the one or more non-fungible assets, and prohibiting the first avatar from entering the closed space if the first user owns none of the one or more non-fungible assets.

17. The video data transmission method according to claim 2,
wherein the virtual space includes a closed space, and
wherein the video data transmission method further comprises the step of permitting a first avatar associated with the first user to enter the closed space if the first user owns a converted non-fungible asset generated by tokenizing at least one of one or more fungible assets as a non-fungible token, and prohibiting the first avatar from entering the closed space if the first user does not own the converted non-fungible asset.

18. The video data transmission method according to claim 2,
wherein the first user owns a plurality of wearable assets that can be worn by a first avatar of the first user in the virtual space, the plurality of wearable assets being included in the one or more fungible assets, and
wherein the video data transmission method further comprises the step of performing, by means of one or more processors, in response to a tokenization request from the first user, a process for tokenizing a set of the plurality of wearable assets as a non-fungible token.

19. A system for transmitting video data including a view of a virtual space in which a plurality of avatars are allowed to participate, the plurality of avatars each associated with one of a plurality of users including a first user,
the system having one or more processors and one or more servers that store user identification information for a plurality of users of the virtual space, a first server of the one or more servers storing one or more server-hosted wallets,
wherein the one or more processors execute computer-readable instructions to:
prepare data for generating a view of a virtual space in which at least a first avatar participates, the first avatar associated with a first user;
transmit the data for generating the view of the virtual space to a display of a user device of the first user;
in response to an asset acquisition request from the user device of the first user in the virtual space,
determine if the user identification information for the first user is associated with any one of the server-hosted wallets;
based on a determination that the user identification information for the first user is not associated with any one of the server-hosted wallets,
generate a first wallet in association with first user identification information for the first user; and
store the first wallet as a server-hosted wallet on the first server in association with the user identification information for the first user;
transfer, in response to storage of the first wallet on the first server, a first non-fungible asset among one or more non-fungible assets that are digital assets for use in the virtual space and tokenized as non-fungible tokens, the first non-fungible asset corresponding to the asset acquisition request, to an address of the first wallet; and
cause the display of the user device of the first user to depict a representation of the first non-fungible asset for selection by the first user.

20. A computer-readable tangible non-transitory storage medium storing a program for video data transmission program that transmits video data including a view of a virtual space in which a plurality of avatars are allowed to participate, the plurality of avatars each associated with one of a plurality of users including a first user, the computer-readable tangible non-transitory storage medium comprising executable instructs that, when executed, cause one or more processors to:
prepare data for generating a view of a virtual space in which at least a first avatar participates, the first avatar associated with a first user;
transmit the data for generating the view of the virtual space to a display of a user device of the first user;
in response to an asset acquisition request from the user device of the first user in the virtual space,
determine if user identification information for the first user is associated with any one of one or more server-hosted wallets stored on one or more servers;
based on a determination that the user identification information for the first user is not associated with any one of the one or more server-hosted wallets,
generate a first wallet in association with first user identification information for the first user; and
store the first wallet as a server-hosted wallet on a first server of the one or more servers in association with the user identification information for the first user;
transfer, in response to storage of the first wallet on the first server, a first non-fungible asset among one or more non-fungible assets that are digital assets for use in the virtual space and tokenized as non-fungible tokens, the first non-fungible asset corresponding to the asset acquisition request, to an address of the first wallet; and
cause the display of the user device of the first user to depict a representation of the first non-fungible asset for selection by the first user.
